(19) United States
(12) Patent Application Publication
(10) Pub. No.: US 2026/0134497 A1
(43) Pub. Date: May 14, 2026

(54) System and Method for Detecting Threats

(71) Applicant: Gunsens Inc., Fort Myers, FL (US)

(72) Inventors: Peter REDFORD, Fort Myers, FL (US); Scott REDFORD, Fort Myers, FL (US)

(73) Assignee: Gunsens Inc., Fort Myers, FL (US)

(21) Appl. No.: 19/414,223

(22) Filed: Dec. 9, 2025

Related U.S. Application Data
(63) Continuation-in-part of application No. 18/912,415, filed on Oct. 10, 2024.
(60) Provisional application No. 63/544,026, filed on Oct. 13, 2023.
(60) Provisional application No. 63/730,421, filed on Dec. 10, 2024.
(60) Provisional application No. 63/881,003, filed on Sep. 12, 2025.

(51) Int. Cl. G06Q 50/26; G08B 25/01

(52) U.S. Cl. CPC G06Q 50/265; G08B 25/016

(57) ABSTRACT

Disclosed implementations provide a system of sensing modules that can operate in conjunction with a Software as a Service (SaaS) backend to detect and alert of various threats. The sensing modules can be installed at fixed locations or can be mobile. All sensing and detection processing can be accomplished by the sensing module or by several sensing modules cooperating on a mesh network or other network communication architecture. Privacy is preserved because all raw sensor data collected for analysis is processed locally at the sensing module(s) and deleted immediately following the completion of analysis. Accordingly, raw sensor data is inaccessible outside of the sensing module(s) which can be secured through hardware and software security techniques. An app can include an alert button and the ability to live stream video images. The sensors can include AI agents and the system can include a drone dispatch module.

### RELATED APPLICATION DATA

This application is a continuation-in-part of U.S. application Ser. No. 18/912,415 filed on Oct. 10, 2024, which claims priority to U.S. Provisional Application Ser. No. 63/544,026 filed on Oct. 13, 2023, the entire disclosures of which are incorporated herein by reference. This application also claims priority to U.S. Provisional Application Ser. No. 63/730,421 filed on Dec. 10, 2024, and U.S. Provisional Application Ser. No. 63/881,003 filed on Sep. 12, 2025, the entire disclosures of which are incorporated herein by reference.

### BACKGROUND

Various threats, such as a potential or actual “active shooter(s)”, a forest fire, severe weather, and other situations which put lives and property at risk, have become too common. For example, “mass shootings”, generally defined as incidents where four or more people are killed or injured by firearm violence have become a severe problem in recent years. Mass shootings are particularly tragic when they occur in schools, supermarkets, churches, parks, or any other place where individuals gather in large groups. There were more than 390 mass shootings in the United States in January to

September of 2024—resulting in more than 375 people dead and 1, 700 injured, according to the Gun Violence Archive (GVA).

Early detection of a potential or actual active shooter can be very effective at minimizing the loss of lives from mass shootings. Further, it is critical for “first responders”, such as police, to quickly ascertain specifics of the situation when responding to an active shooter report. For example, it is important to understand how many potential shooters are in the area, where the shooters are located (e.g., which classrooms of a school building), the immediacy of the threat, and the well-being of hostages or other victims. Such early warnings and information also apply to other threats, such as forest fires, extreme weather events, burglaries, and the like.

It is known to use image recognition techniques and acoustic gunshot sensors to detect a potential shooting. However, conventional detection systems do not provide adequate information and introduce many privacy issues since they are often transmitting data, including image data, in public areas. Accordingly, known systems have not been applied with great effectiveness to date.

### SUMMARY

Disclosed implementations provide a complete system that includes AI enabled sensing modules that can operate in conjunction with a Software as a Service (SaaS) backend to detect various threats. The sensing modules can be installed at fixed locations or can be mobile. All sensing and detection processing can be accomplished by the sensing module or by several autonomous sensing modules cooperating on a mesh network or other network communication architecture. Privacy can be preserved because all raw sensor data collected for analysis can be processed locally at the sensing module(s) and deleted immediately following the completion of analysis.

Accordingly, any collected raw sensor data is inaccessible outside of the sensing module(s) which can be secured through hardware and software security techniques. The sensing modules can be configured to merely produce a “yes/no” indication of a particular threat, or an indicator of a type of threat from amongst multiple threats, along with an associated confidence level of such indication.

Each sensing module can be registered in a centralized system in association with the current location of the sensing module. For example, the sensing module may be fixed in a specific room/location or can be mobile and tracked through GPS services or other location services. Registration can be accomplished with a notification endpoint device associated with one or more sensing modules (e.g., a mobile phone, tablet or personal computer) by obtaining an ID code of the sensing module (e.g., scanning a QR code, or other code, on the sensing module). The location can be automatically supplied through an interface of the notification endpoint device during the registration process. The location can be manually specified using a map or a floorplan of a building, by GPS coordinates, or in any other known manner.

Multiple sensing modules can be located in a building or other area.

Accordingly, disclosed implementations can detect the path/movement of a threat, such as an intruder, an active shooter, a fire, or weather event, as a function of time. Sensing modules can include an image sensor and various additional sensors, such as IR sensors, audio sensors, Radar, LiDAR, or the like. Alarm signals, i.e., signals indicating that enough information has been gathered to validate an active threat, can be transmitted to designated administrators, police, security, other stakeholders and/or first responders, or the public, in any manner in accordance with system configuration. For example, detection of a threat can trigger a call to the cell phone of a school administrator and/or 911 or other emergency personnel. The general public can be notified through cell phones, a public alarm (e.g., a public address system), or the like.

The alarm can vary based on the above-noted confidence level. The confidence level can be adjusted over time. For example, multiple detections (by different senor modules) may be processed to give a higher level of confidence. Confidence can be combined as a weighted sum of confidence levels from multiple sensors modules over time. Multiple sensing modules within the same coverage area or the same threat zone that detect a threat within a short time window can result in an increased confidence level. For example, if two sensing modules that are located geographically close to one another both detect a specific threat with a 70% confidence within a short period of time, the confidence level could be boosted to 90%.

The threat and/or associated confidence level can be based on various detected actions. For example, in detecting a potential shooter, a raised rifle/pistol could be deemed more significant than a slung/holstered rifle/pistol. Shooting threats can be associated with the attributes of a person (i.e. face, gait, clothing . . . ) to generate a unique threat-signature. The threat signatures of multiple threat signals can be compared to check whether the source of the threat, detected by multiple sensing modules or by one sensing module at multiple times, was the same. For example, in the case of two active shooters, the threat signature would be different for each shooter based on the distinct characteristics of each shooter.

In the case of a gunshot, sound may be detected at several sensing modules, with volume measured on each sensing module to help determine the location of the shot by triangulation or other algorithms. A shooting threat may be analyzed to determine additional attributes that can identify contexts such as an impending ambush.

For data security and accuracy, raw sensor data can be analyzed by an Artificial intelligence (AI) module that is located at the sensing module depending on context. In one example, a multi-step sequence of stacked neural networks may incrementally review the data in seriatim and cancel further analysis if a detection confidence is below a predetermined threshold. Not only does this further protect privacy, but also further optimizes onboard resources for analyzing only significant threat subjects and threat contexts.

Authorized gun holders (for example, a person that has opted into a database using identifiable attributes such as a face and is authorized to enter a protected premises), such as a school security or police officers, can be registered and excluded from threat detection/alarm generation. Sensing modules can communicate with other systems, such as legacy alarm systems and smart doors. Sensing modules can be integrated into light switches, wearable devices, doorbells, bodycams, drones (e.g., at a traffic stop, an officer can use the drone to detect a shooting threat inside a car before approaching).

### BRIEF DESCRIPTION OF THE DRAWING

Disclosed implementations are described herein with reference to the attached drawing.

FIG. 1 is a high-level block diagram of a system for detecting threats in accordance with disclosed implementations.

FIG. 2 is a schematic illustration of the relationship between a coverage area and a sensing module.

FIG. 3 is a block diagram of a threat detection system with examples of various ways that the components can be distributed within the system.

FIG. 4 schematically illustrates examples of the concept of threat zones.

FIG. 5 is a block diagram of an example of a threat detection process in accordance with disclosed implementations.

FIG. 6 is a schematic illustration of a threat data structure.

FIG. 7 is a diagram showing occlusion points of a weapon.

FIG. 8 is a block diagram of an example of a sensing module in accordance with disclosed implementations.

FIG. 9 is a block diagram of an overview of a data pipeline in accordance with disclosed implementations.

FIG. 10 is a flowchart of an example of the operation of a threat processor in accordance with disclosed implementations.

FIG. 11 is a flowchart of an example of operation of a threat server in accordance with disclosed implementations.

FIG. 12 is a flowchart of an example of operation of a notification server in accordance with disclosed implementations.

FIG. 13 is a flowchart of an example of an endpoint application in accordance with disclosed implementations.

FIG. 14 is a flowchart of a process of provisioning a sensing module using the endpoint device/app in accordance with disclosed implementations.

FIG. 15 is a flowchart of a process of an autolaunch process in accordance with disclosed implementations.

FIG. 16 is a flowchart of a process of a pre-provisioning process in accordance with disclosed implementations.

FIG. 17 is a flowchart of a provisioning process in accordance with disclosed implementations.

FIG. 18 is a flowchart of a post-provisioning process in accordance with disclosed implementations.

FIG. 19 is a flowchart of an endpoint device view mode in accordance with disclosed implementations.

FIG. 20 is a flowchart of a threat handler in accordance with disclosed implementations.

FIG. 21 is an exploded view of an example of a “single gang” sensing module in accordance with disclosed implementations.

FIG. 22a is an exploded view of a ceiling mounted sensing module in accordance with disclosed implementations.

FIG. 22b shows other views of the sensing module of FIG. 22a.

FIG. 23 is a schematic illustration of the optics and image processing of the sensing module of FIG. 22a.

FIG. 24 illustrates the fisheye image used in the image processing of FIG. 23.

FIG. 25 illustrates the separation of the overhead view and the periphery view of FIG. 23.

FIG. 26 illustrates the rectified periphery sections of FIG. 23 with the horizontal line along the bottom of the image indicating a reasonable cutoff where the cut data is to be used separately for overhead detection.

FIG. 27 illustrates an SOS button of a user interface in accordance with disclosed implementations.

FIG. 28 illustrates a tab bar of the user interface in accordance with disclosed implementations.

FIG. 29 illustrates a locked screen notification of a user interface in accordance with disclosed implementations.

FIG. 30 illustrates a map of a user interface in accordance with disclosed implementations.

FIG. 31 illustrates a location tab bar of a user interface in accordance with disclosed implementations.

FIG. 32 illustrates a history screen of a user interface in accordance with disclosed implementations.

FIG. 33 illustrates a filter definition box of a user interface in accordance with disclosed implementations.

FIG. 34 illustrates a floor plan details screen of a user interface in accordance with disclosed implementations.

FIG. 35 illustrates a member detail screen of a user interface in accordance with disclosed implementations.

FIG. 36 illustrates a comment input screen of a user interface in accordance with disclosed implementations.

FIG. 37 illustrates a live stream display of a user interface in accordance with disclosed implementations.

FIG. 38 illustrates an example a hardware SOS panic button as a hardware tag with an actuator.

FIG. 39 illustrates an example of a hardware SOS panic button with a QR code that allows a camera of a mobile phone to read the QR code and present a link to a SOS panic button.

### DETAILED DESCRIPTION

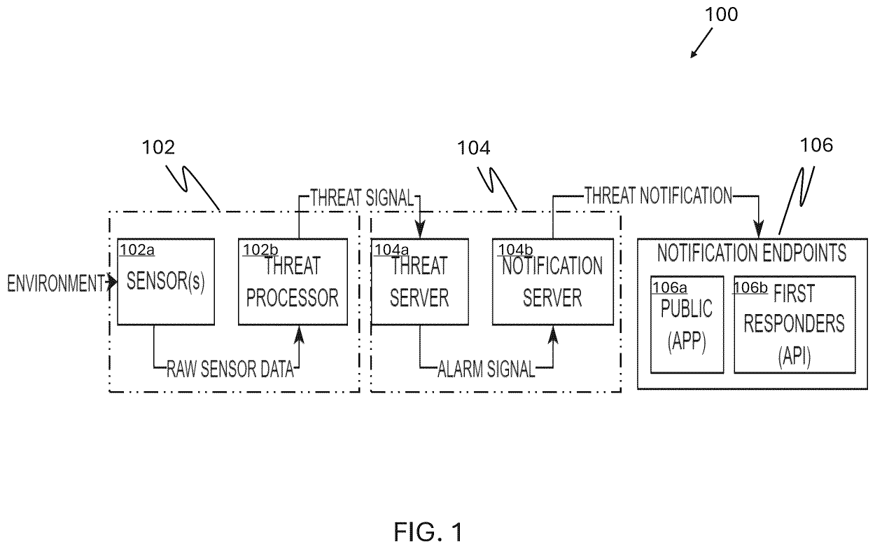

FIG. 1 is a high-level block diagram of a system for detecting threats in accordance with disclosed implementations. System 100 includes sensing module(s) 102, threat notification module 104, and Notification endpoints 106. Only 1 sensing module is shown in FIG. 1. However, as described below, there can be one or more sensing modules as dictated by the system requirements for detection. Each sensing module 102 includes one or more sensors 102a (a “sensing package”) and a threat processor 102b, which processes raw data from sensors 102a to generate a threat signal which can include a confidence level. Note that the raw sensor data need not be communicated to any element outside of sensing module 102. The threat signal can also include identification Information relating to the sensing module generating the signal, and additional metadata indicating, for example, a threat subject and threat context (described in greater detail below).

Threat notification module 104 includes threat server 104a, which can generate an alarm signal based on one or more threat signals. Threat server 104a can also include a database which stores the identification information of sensing module 102 in association with a location of threat sensing module 102, either directly or indirectly. The location information and identification information can be used to assist with threat zone assignment where multiple sensing modules 102 have overlapping coverage areas (i.e., zones of which the sensing modules are able to detect a threatening situation) or otherwise detect a threat that is determined to be the same threat. In such a case, threat server 104a can aggregate multiple threat signals from multiple sensing modules and consolidate the same into a single alarm signal. This is also described in greater detail below.

Threat notification module 104 can also include notification server 104b which determines a manner of notification as described in more detail below. Notification endpoints 106 can include devices 106a associated with the public (e.g., mobile phones) and services 106b associated with first responders. Notification endpoints can be part of existing systems and thus can be external to the threat determination process but are illustrated as part of system 100 in FIG. 1 for clarity. Notification endpoints can include, for example, a mobile phone/app, a web app, an email address, and SMS number, a PSAP or PSAP integrator like RAPIDSOS or Everbridge, or third-party integrators that ingest an alarm signal corresponding to a threat. Notification Endpoints can also act as a trigger and send a Threat Signal. For example, a mobile phone app may have an SOS button that sends a threat signal to a threat server on premises or in the cloud. This is discussed in greater detail below. Notification server 104b can be configured to store a notification configuration in association with at least one sensing module 102 and can be configured to translate an alarm signal from threat server 104a into a threat notification to be sent to one or more devices which make up the set of notification endpoints 106.

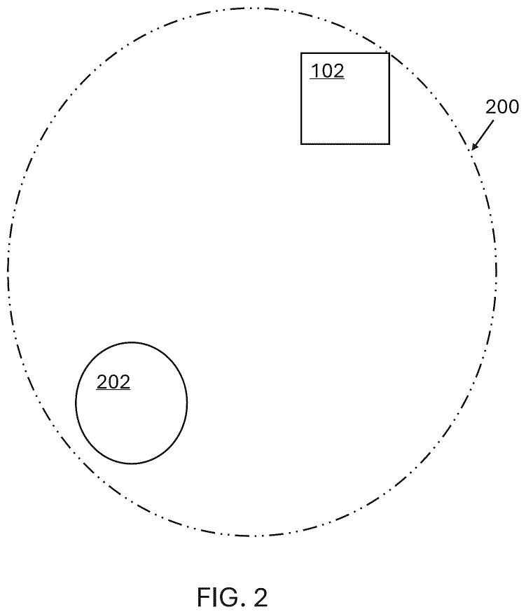

FIG. 2 illustrates an example of the relationship between a coverage area and sensing modules. Sensing module 102 is associated with coverage area 200. Sensing module 102 can be physically located in coverage area 200 or otherwise located to sense activity in coverage area 200, to thereby be capable of detecting threat 202 which occurs within the coverage area. Typically, the coverage area for sensing module 102 is defined by the sensors and mechanical features of sensing module 102. The phrase “coverage area”, as used herein, refers to an area in 2-dimensional or 3-dimensional space for which sensors of a specific sensing module 102, or combination of sensing modules 102, can detect activity.

In an alternative example, sensing module 102 and threat module 104 can be incorporated into a single module or device, referred to as a “sensing module” or “threat detection device” herein. Alternatively, the threat server and notification server can be included in one, multiple, or all sensing modules in a mesh network or the threat server and notification server can be in a cloud instance that is connected to a single threat detection device or mesh network that contains threat detection devices that are composed of at least one sensing module. The phrase, “mesh network, as used herein, refers to a short range communications network of devices capable of communicating with other devices in the network. A “mesh link” is used for exchanging and routing data within a mesh network.

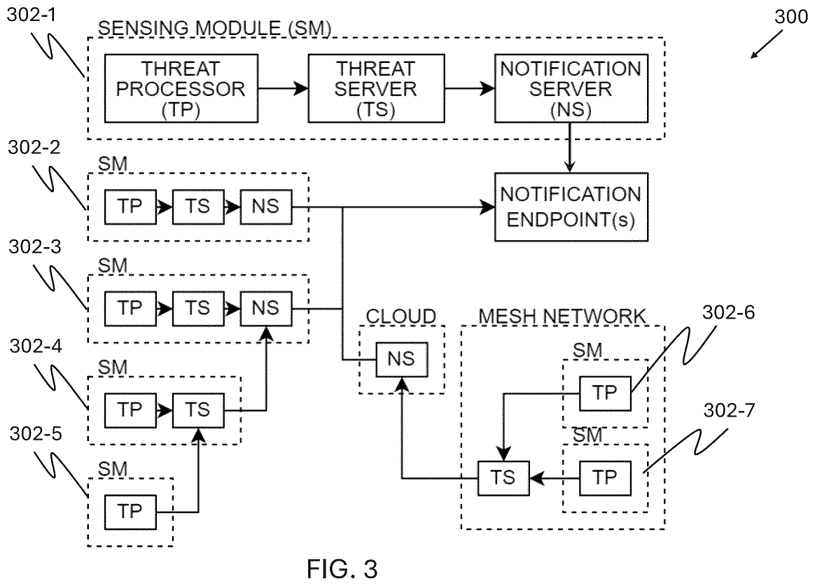

FIG. 3 illustrates an example of threat detection system 300 with examples of various ways that the components can be distributed within the system. As illustrated in FIG. 3, system 300 includes sensing modules 302-1 to 302-6. In this example, sensing modules 302-1, 302-2, and 302-3 all include, in addition to sensors, a threat processor, and threat server and a notification server and all coupled to a set of notification endpoints, through a communications network, such as the Internet. Sensing modules 302-2 and 302-3 are also coupled to a cloud-based notification server. Also coupled to the cloud based notification server are sensing modules 302-4, 302-5, 302-6, and 302-7 where 302-5, 302-6, 302-7 are indirectly coupled through a threat server external to their own sensing modules. Sensing module 302-4 includes, in addition to sensors, a threat processor and a threat server. Sensing module 302-5 includes only sensors and a threat processor (similar to the example of FIG. 1) and leverages the threat server of sensing module 302-4. Sensing modules 302-6 and 302-7 are similar to the example of the sensing module in FIG. 1 and communicate with a common threat server over a mesh network. All of these examples can be mixed and matched in a threat detection system as will be apparent to one of skill in the art based on the disclosure herein. The configuration and operation of the elements described above will now be described in more detail. As noted above, a module can include sensors, a threat processor, and depending on configuration, a threat server. The primary function of the sensors is to capture environment data that can be interpreted by the threat processor as a potential threat subject or threat context. The sensors may consist of, for example, any one of, or a combination of, image sensors, acoustic sensors, RADAR, LiDAR, infrared sensors, or proximity sensors.

In some disclosed implementations, the threat processor includes a neural core and a network core. The primary function of the neural core is to analyze raw sensor data and generate a threat signal if a threat or threat context are detected. The primary function of the network core is to route the threat signal to a threat server. In one example, where the threat processor and threat server are part of the same sensing module, threat server may reside on the neural core, network core or both.

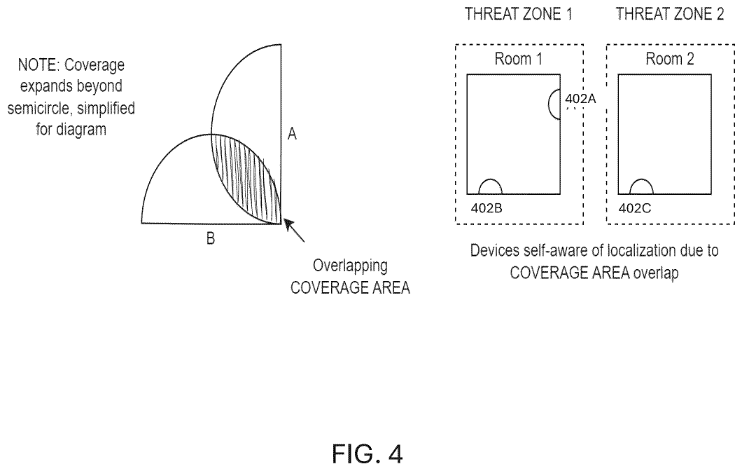

FIG. 4 illustrates the concept of threat zones where multiple coverage areas corresponding to multiple respective sensing modules overlap such that a threat detection by more than one sensing module in the same threat zone increases a confidence level of a valid, active threat. As shown in FIG. 4, sensing modules 402A and 402B are positioned in Room 1 to have coverage areas that overlap (as shown in the diagram at the left of FIG. 4) to define Threat Zone 1. On the other hand, there is only one sensing module, 402C in Room 2 to thereby define Threat Zone 2. Multiple detections, by multiple sensing modules, in a threat zone (such as Threat Zone 1, have a higher likelihood (heavier weight to confidence level) to generate an alarm signal than multiple detections across multiple threat zones.

In addition to consolidating threat signals to generate alarm signals, the threat server can also fine-tune operative modes and settings such as heightened states of awareness during an ongoing threat event. For example, contextual data sent to the threat server(s) from other sensing modules can be used to adjust the determined confidence level of a threat and thereby reduce alarm signal latency. Contextual data can include recent threat signal transmissions, threat confidence level data, and additional threat signal metadata. Contextual data can be included in the threat context component of a threat signal. Real-time configurability of the threat server based on context can help reduce false positives as well as speed up detection of known, ongoing threats. For example, a sensing module configured for sensing in low lighting may take a long time to recover from a bright muzzle flash before it can effectively detect again. Threat processors in the same threat zone may reconfigure in real-time to specialize for the incident where one sensing module focuses on low light sensitivity with the added exposure delay, while the other configures itself for bright flashes such that they can be detected immediately and without delay. This real time reconfiguration of two sensing modules in the same threat zone allows the threat detection system to adapt to scenarios fully autonomously to increase the amount of real time actionable data that it can provide to first responders and the public. Another example use-case would be adjusting sensitivity to gun-like devices like a water hose gun or post office scanning gun. A verified detection of said gun-looking object that is not a threat can then be communicated to other sensing modules in the same area, shared threat zone or not, such that those devices calibrate to expect the use or traversal of something that looks like a water gun or scanning gun in the coverage areas. Lastly, a location-wide reconfiguration could be as simple as adjusting sensing module camera sensor profiles to increase exposure for low lighting situations because it is night time. This adjustment based on situational context makes the system very adaptive.

The notification server(s) can collect information from multiple sensing modules and even multiple mesh networks of sensing modules, typically via threat servers, to provide a consolidated set of actionable data to first responders and the public via the notification endpoints. Notification servers receive alarm signals from threat servers and generate threat notifications which are sent to the notification endpoints. such actionable data includes, but is not limited to:
Number of actors presenting as threats (person count from threat context)
Number of firearms (weapon count from threat subject)
Number of hidden firearms (recent loss of detection of a threat)
Status of persons in the area (e.g., deaths and injuries)

The notification server(s) can use alarm signals and the location's floorplan from a floorplan database to pinpoint the location of a threat in 3-dimensional space. The Notification server knows the location of each sensing module in a floorplan and can use this to infer the location of a threat signal source from the threat signal metadata. In implementations that include an uplink and a mesh link, the network core (noted above and described in greater detail below) of the threat processor facilitates routing and communication from the threat processor to the mesh network via the mesh link or to a cloud-based threat server, notification server, or other administrative services and integrations. The network core can contain interfaces for wired and wireless communication methods including but not limited to Bluetooth, Wi-Fi, 4g LTE, 5g, meshing technology, and ethernet.

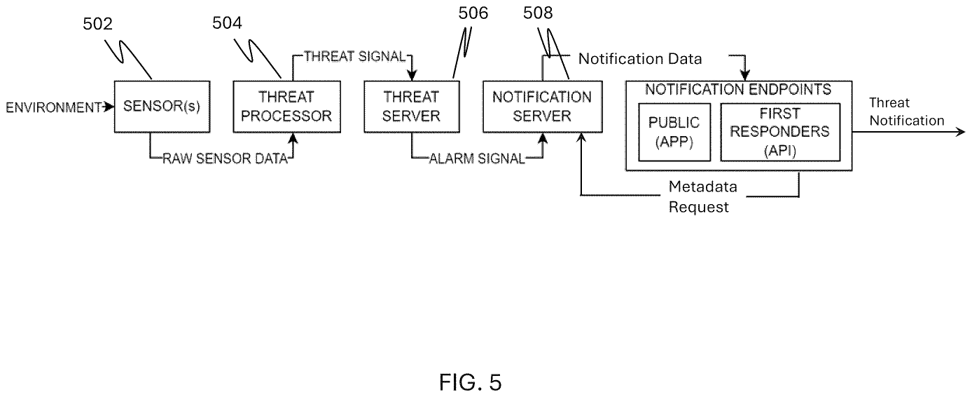

An example of the threat detection process is described below in connection with FIG. 5. At 502, a sensor in the sensing module ingests environment information to produce raw sensor data which is then fed directly into the threat processor within the sensing module for analysis. At 504, the threat processor analyzes the raw sensor data from one or more sensors for a threat subject and a threat context and, in response to at least one of a threat subject and/or a threat context being found, the threat processor autonomously generates a threat signal. The threat signal is communicated to an associated (e.g., nearest) threat server which may reside in the same sensing module as the threat processor, another sensing module, another device within the mesh network, or in the cloud. At 506, the threat server continuously or periodically evaluates threat signals from one or more threat processors and, over time, determines if enough information has been collected to validate the pending threat or to enhance the confidence level of a previously validated threat. When a threat is validated by the threat server, the threat server generates an alarm signal which is communicated to an associated (e.g., the nearest or designated) notification server. Note that a pending threat is a collection of accumulating threat subject and threat context data that is periodically evaluated for validation by the threat server. At 508, the alarm signal is translated from an alarm signal into a threat notification and transmitted to notification endpoints such as first responders and the public.

The translation of step 508 can include a conversion of data. For example, an Alarm signal is holding notification data which essentially states “this sensor with this ID has a verified threat that has triggered an alarm”. The Notification Server then, for example, can send out the notification data that contains sensor ID and location data to notification endpoints. Notification Endpoints can then request metadata, for example, floor plans from the notification server or another server, and combine the data to create the threat notification the threat notification data (which specifies location i.e. address +sensor ID and location on floorplan, and/or other metadata).

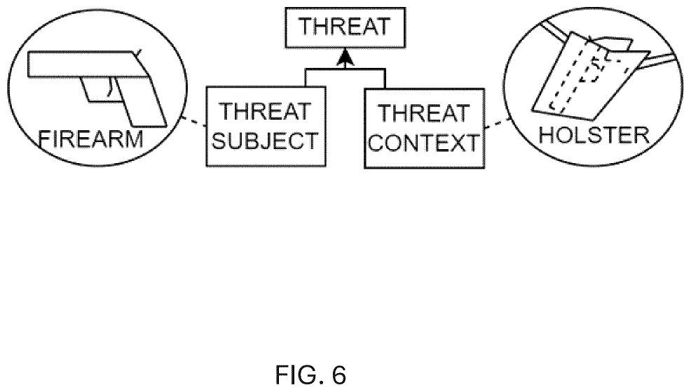

As noted above, and illustrated in FIG. 6, a threat can be expressed as a data structure and can be composed of a threat subject and a threat context. A “threat subject” is the specific source or type of threat (e.g. a threatening weapon, a fire, a meteorological storm, or the like). A “threat context” is the context of which the threat subject exists in and how it is interacting with the environment. This helps identify, for example, if a firearm is actively held in a threatening manner or safely holstered, or if a storm or fire is likely to do damage to persons or property. When the threat context and/or a threat subject is determined (in the manner described in detail below) to promote a pending threat into a threat, an alarm signal is generated. The threat signal is used to communicate information about a pending threat to a threat server. A threat signal can include the threat subject, the threat context, and metadata including but not limited to:
a confidence level
a timestamp
a threat zone id (helps identify if detections from separate threat processors are sourced from the same coverage area)
a unique non-identifying threat-signature

The threat signal may contain a unique, possibly non-identifying, signature of the threat such that multiple threat signals can be determined to come from the same threat or different threats.

The threat processor protects privacy by extracting data from the raw sensor data and constructing the notification data with the extracted data. Therefore, when the threat signal is transmitted, only meta information about the raw sensor data is transmitted and the raw sensor data can be deleted from the sensing module. “Raw sensor data”, as used herein, refers to substantially unmodified signals from sensors. For example, the sensing module could include a camera that captures video data. The actual video data need not be transmitted by the threat processor of the sensing module.

A threat subject can be identified by visible occlusion points that are trained into a neural network of the neural core using the occlusion point framework. These occlusion points are critical in fine-tuning training data and for determining the level of annotation of training data (i.e. occlusion labeling).

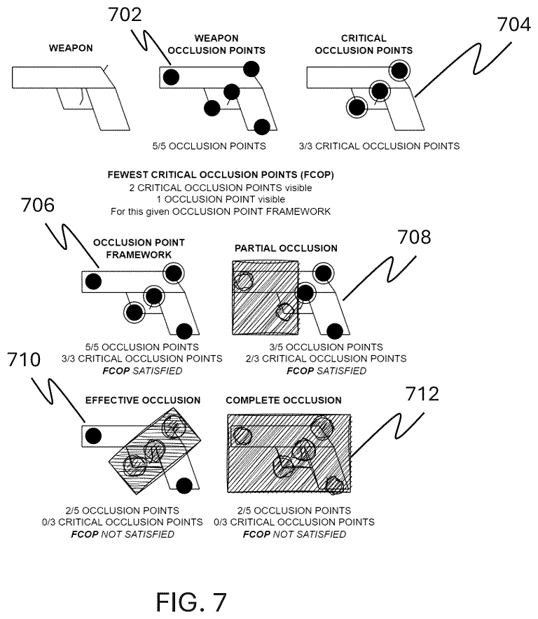

Occlusion points are locations on the shape of a threat, e.g., a weapon, that help to confirm the presence of the threat. For example, as shown in FIG. 7, a handgun's occlusion points may include points on the barrel, the hammer, the top of the trigger, the lower trigger guard, and the bottom of the grip, as shown at 702. A critical occlusion point is an occlusion point of which presence is important to confirm the presence of the threat. In some implementations, a minimum number of critical occlusion points must be visible in order to identify a threat. Fewest Critical Occlusion Points (FCOP) represents the minimum number of critical occlusion points that, together with non-critical occlusion points, is needed to reliably confirm the presence of the threat. Non critical occlusion points do not provide enough information to certify the presence of a threat and may even be confusing like in the instance of a long barrel of a shotgun versus a broomstick. However, these non critical occlusion points significantly help determine the presence of a gun when in context of detected critical occlusion points, like a trigger guard or hammer.

For example, as shown at 704, in a handgun, the hammer, the top of the trigger, and the lower trigger guard can be defined as critical occlusion points. It could be required, for example, that two of those three critical occlusion points, along with at least one non-critical occlusion point, must be visible to confidently identify the shape as a weapon. An occlusion point framework, the composition of which is determined typically per threat shape, is a set of occlusion points used to train a neural network to detect the presence of the threat. For example, an occlusion point framework for a handgun

(shown at 706) is different from an occlusion point framework for a rifle due to substantial weapon shape differences. Further, the occlusion point framework for a fire is very different for the occlusion point framework for a weapon. Thus, the occlusion point frameworks will differ based on application. Of course, a sensing module can be trained on more than one type of occlusion point framework to thereby detect multiple types of threats.

In a situation where not enough occlusion points are visible, the threat cannot be confidently confirmed. Training data can be annotated as such to reduce false positives and increase network sensitivity to occlusion points. Low confidence detections due to partial occlusion (shown at 708) can trigger additional analysis such as, in the case of a potential handgun detection, a holster context detection, and can also be boosted by gesture detection to help provide context to the potential threat. For example, a weapon shape that has moved from full view to partial or effective occlusion (shown at 710, partial occlusion and 712, full occlusion) can be indicative of an ambush on a live threat detection system utilizing a network trained on such an occlusion point framework. Training of neural networks using annotated data (supervised training) generated with occlusion point frameworks enables the confirmation of the presence of threats even when shapes are partially occluded.

As noted above, a threat notification is a signal that is transmitted by a notification server and received by a notification endpoint. Notification endpoints may be hosted by mobile apps, web apps, public-safety answering points, and third party integrations. For example, a mobile phone app, available to the public and to first responders, can receive a threat notification that sounds an audible alarm and displays a two or three-dimensional map with the exact location of the threat. A mobile phone app can provide first responders, and others, with real-time actionable data, enabling a faster response to the threat by bypassing human-operated dispatch systems that may introduce human error and increase response times. Pinpointing the threat's location in three-dimensional space guides first responders to the appropriate location, such as a specific floor of a specific building. Pinpointing the threat's previous locations provides first responders to potential victim areas where first aid may be needed and potentially identifies the direction of the threat's movement. A threat signal can also include instructions for avoiding the threat, such as closed roads and/or evacuation routes.

The threat processor of the disclosed implementations can determine, for example, the following from threat subjects and threat contexts:
Static state of weapon (holstered, slung, drawn, partly concealed)
Dynamic state of weapon (in motion, recently concealed)
State of shooting threat (person waiting in ambush, prone, other stances)
Location and distance of threat in 3d space
Number and position of armed persons versus unarmed persons in a location
Friend or foe determination

In the case of networked devices, such as devices on the same mesh network, primary devices are typically used as gateways for the mesh network and fully utilize their onboard uplinks to relay information between the network and external infrastructure such as cloud servers. In some implementations, primary devices also host threat servers or other threat detection system servers. However, primary devices can delegate these roles to secondary and tertiary devices as needed to offload work and free-up additional compute resources. Primary devices keep track of device connectivity and device health across the mesh network by occasionally requesting device health checks from other devices. Primary devices may request staggered offloading for uplink relay with other devices to enable faster sign-of-life reports back to external infrastructure in situations where singular devices are limited by the frequency of outgoing connections. This allows for much quicker emergency reporting if any one device is throttled for an unexpected reason by uplink technology or carriers.

Secondary devices are backup devices that can take on the same roles as primary devices in case of primary device error/failure. For example, secondary devices can be instructed to take over roles including but not limited to uplink handling, mesh network re-topologizing, mesh communication gateway routing, and threat server hosting. Tertiary devices are primary and secondary devices that relay network communications and generate self-checks. For example, a tertiary device can be used for mesh network re-topologizing if better uplink connectivity is found on another tertiary device.

Mesh networks of sensing modules can interface with other devices and their infrastructure using compatible wireless technology. Allowing mesh network sensing modules to communicate with external devices imposes security risks. To mitigate this risk, a secure traffic tunnel, such as a VPN, can be established after external device identity verification, such that the external device can tunnel through the connected mesh network up to its own cloud infrastructure. For example, a Bluetooth smoke detector provides a vendor authentication key while contacting a sensing module by using the threat detection mesh network's API. The sensing module then verifies the authentication key and establishes a secure tunnel from the external device to the external device's cloud infrastructure endpoint. Such an architecture provides connectivity redundancy in the event of communication loss between external devices and their cloud infrastructure due to events such as a power outage.

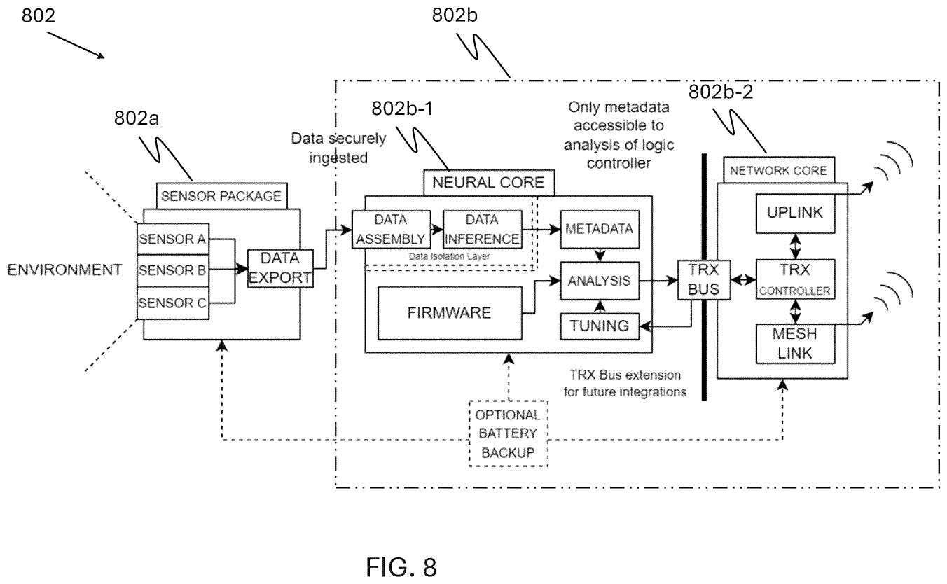

FIG. 8 illustrates an example of sensing module 802 (similar to sensing module 102 of FIG. 1) in detail. Sensing module 802 can be powered directly from line voltage (e.g., 120 v). An optional battery backup provides backup power in the event of a line voltage power failure. Sensor package 802a uses one or more sensors to monitor the environment and produce sensor data, such as image data, audio data, heat data, and the like. The sensor data can be preprocessed and exported as raw data for export to the neural core 802b-1 of threat processor 802b. The neural core receives the raw sensor data and assembles it into a readable format in preparation for data inference operations by one or more neural networks of neural core 802b-1. Raw sensor data can be protected from access by anything other than the data assembler and the neural network(s) of the neural core doing data inference. The data inference process can be executed by the neural network(s) with multiple optimization steps described below.

The metadata produced by the data inference process is analyzed locally by the sensing module and adjusted based on configured sensor tuning parameters as well as live sensor tuning parameter updates. These steps allow sensing module(s) 802 to be individually and autonomously tuned to their environment to maximize the detection effectiveness of the sensing module. Live tuning can be accomplished during an ongoing threat event where sensors pass lower confidence threat signals onto threat servers which would otherwise be filtered out as potential noise. This enables an

[symbol]

“overdrive” mode, in which, if a threat has been detected, a threat signal is generated and sent to a threat server. In this implementation, the threat server can be hosted in the T RX controller on network core 802b-2 of threat processor 802b.

The threat server contained within network core 802b-2 rather than the neural core 802b-1, better facilitates aggregation of metadata from other devices and ensures data flow is typically unidirectionally out of the neural core with regards to metadata and threat signals. The TRX bus enables additional hardware-connected threat processors to interface with the T RX controller of network core 802b-2, further adding to the usefulness of hosting a threat server on the TRX controller. Threat signals can be received by the T RX controller's threat server via uplink, mesh link, directly connected threat processors, and threat processors connected via the T RX bus.

A conventional AC to DC converter can be used to translate 120 v AC power into 5V DC to supply 5V power to the sensing module 802. Additional generic switching voltage regulators can be used to generate other voltages that are not extremely sensitive to interference. For example, the mesh module power could be 1.8V and a cell module power on the T RX board could be 3.8V sourced from the separate PWR board as long as proper filtration is done on the T RX board. However, the neural processor part of the neural core 802b-1 on the NVB (Neural vision board) and its companion devices require extremely high quality power. As such, 5V is supplied directly to the neural core where it is then translated to 0.8V, 1.1 V, and 1.8V with dedicated PMICs and regulators. (TRX) (Network Core)

[symbol]

The network core 802b-2 bridges power between a power board and the NVB (neural vision board) which houses the neural core 802b-1. It also contains a mesh module (e.g., and nRF5340, a wireless System-on-Chip (SOC) developed by Nordic Semiconductor) as well as a cell module (EG915Q-NA, an LTE Cat 1 bis module designed specifically for Machine-to-Machine (M2M) and Internet of Things (10 T) applications). The mesh module acts as a mesh network link as well as the T RX controller in this implementation, while the cell module acts as the Uplink. The nRF5340 has onboard 2.45 GHz wireless communication capabilities which enable interaction between the device and mobile phones via Bluetooth for installation and provisioning. It also includes mesh networking capabilities that can run in parallel to communicate to other mesh networked devices running on mesh network protocols like Open Thread.

The TRX controller (mesh module) is connected to the uplink (cell module) in this implementation via UART. Due to very minimal bandwidth requirements on the device, UART works robustly. The I-JART traces are also not accessible to external probing/snooping without substantial physical modification to the device. The mesh module also contains a secure bootloader, ARM Trustzone, and other heavy-duty security features that facilitates constant reverification of the identity of components in a Zero Trust Environment, even at the hardware level. The T RX board interfaces with the NVB via encrypted UART. Under the assumption that communication between both boards could be intercepted, both the T RX controller and neural core work in a Zero Trust Environment and constantly verify all communications between each other. The transceiver core also manages power control for the entire system. Thus, if potential tampering is detected, it can fully shutdown the neural core to prevent unintended operation and radio home about an active issue. Neural core 802b-1 can contain a very high performance neural processor. For example, the Hailo HI 5 can be used as the neural processor. This processor requires external Low Power Double Data Rate 4 (LPDDR4), a type of synchronous dynamic random-access memory (SDRAM) designed primarily for mobile devices, (MT53EI G32D2FW-046 IT: B-Micron SDRAM) for computation as well as an

[symbol]

Embedded MultiMediaCard (eMMC), a type of flash storage commonly used in portable devices, to house the operating system (EMMCI 6G-IB29-70H01—Kingston eMMC). The neural core can be compiled and “fitted” to the hardware to run as efficiently as possible. The neural core can communicate with onboard internal and external generic temperature sensors and current sensors to monitor its own power consumption and heat generation to identify anomalies during runtime as well as throttle performance as needed to maintain safe operating conditions. The neural core can operate in a zero trust environment where it re-verifies the identity of onboard components (e.g., eMMC serial, flash serial/OTP, T RX Controller signature key, etc.) periodically. The neural core can identify anomalies, restrict its own processing or communication with the T RX controller of network core 802b-2 in the event of tamper detection to prevent unintended operation.

In this example, the neural core can interface via its ISP to a primary optical sensor via Mobile Industry Processor Interface-Camera Serial Interface 2 (MIPI-CS12) over 4× MIPI data lines. The sensor can be an 8.3 MP rolling shutter extremely low-light capable, full color image sensor. A custom 180 degree FOV lens with an extremely small TTL that enables small form-factor solutions can be fitted over the image sensor.

Shielding and other methods can be applied when routing the very high data rate LPDDR4 and MIPI-CS12 signals around the high current density power distribution due to potential interference and to protect these data signals from any close proximity radiation of the PWR board power filtering as well as the two wireless communication devices (e.g., cell and mesh modules) of the network core.

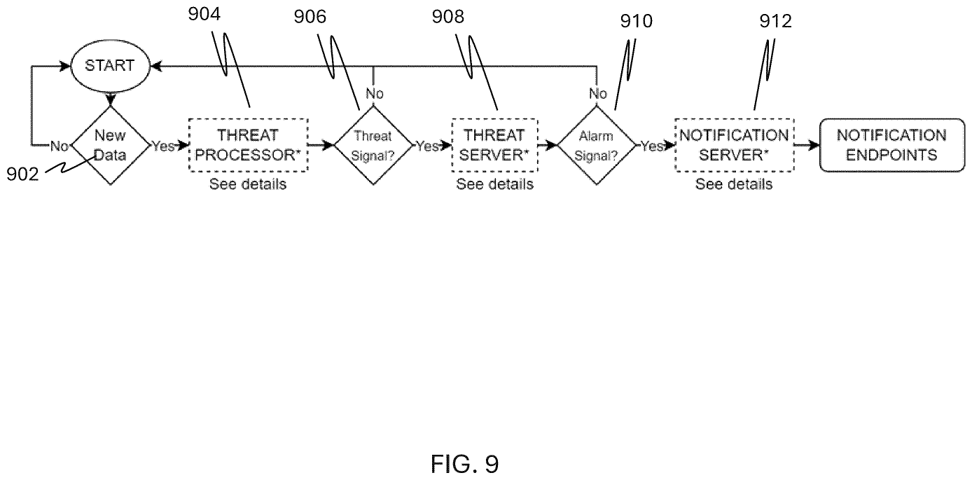

FIG. 9 illustrates an overview of a data pipeline of disclosed implementations. Elements in dotted lines in FIG. 9 are described in detail with respect to other FIGS herein. At 902, if there is new environmental data, a threat processor ingests the environmental data and processes the environment data from the sensing module at 904. If a threat processor has enough confidence in its detections, i.e., the confidence is at or above a threshold level, of a threat subject or a threat context, a threat signal is generated and sent to a threat server at 906. At 908 a threat server accumulates threat signal data until the threat server has enough confidence that a valid threat has been identified. At 910, once a valid threat has been identified, the threat server sends an alarm signal to a notification server. The notification server receives an alarm signal and, depending on its configuration, sends out threat notifications to notification endpoints at 912.

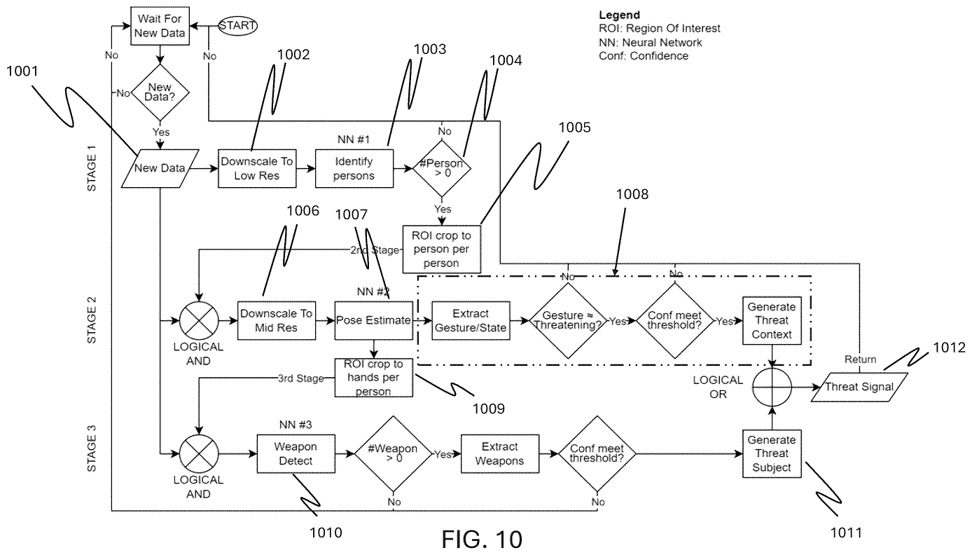

FIG. 10 illustrates an example of operation of a threat processor in accordance with disclosed implementations. When new sensor data is available, the new sensor data is transmitted to the threat processor as full resolution “new data” at 1001. At 1002 the sensor data is downscaled to optimize high level analysis. At 1003, threat context detection is executed on Neural Network #1 on the downscaled sensor data, for example, scanning for humans. Neural Network #1 can be a convolutional neural network. At 1004, if a person is detected, regions of interest are cropped, per person, at 1005, and passed to a 2nd stage for mid resolution downscaling of selected regions of interest, at 1006. The data is thereby optimized depending on approximate size and distance of a detected human form.

Pose estimation is executed on the processed regions of interest in neural network #2, which also can be a convolutional neural network, to extract gesture and/or state information for threat context data, at 1007. Gestures can be extracted and context filters, such as threatening gestures and confidence thresholds, can be applied, at 1008, to reduce false positives. Pose estimation with person region of interest crop is used to determine region of interest crop coordinates of hands and other threat proposal locations for deeper analysis in stage 3.

Hand and threat proposal region of interest crop coordinates are passed to stage 3, at 1009, for full resolution weapon detection in threat proposal locations by neural network #3, at 1010. If weapons are detected, by the neural network and confidence threshold is met, a threat subject is generated, at 1011. Threat context data and/or threat subject data is exported from the threat processing pipeline together, or independently, as threat signals at 1012. A threat signal can be sent containing either or both of a threat subject and threat context. The fusion of data between separate sensing modules enables a threat subject from one sensing module and a threat context from a separate sensing module to be determined to come from the same source.

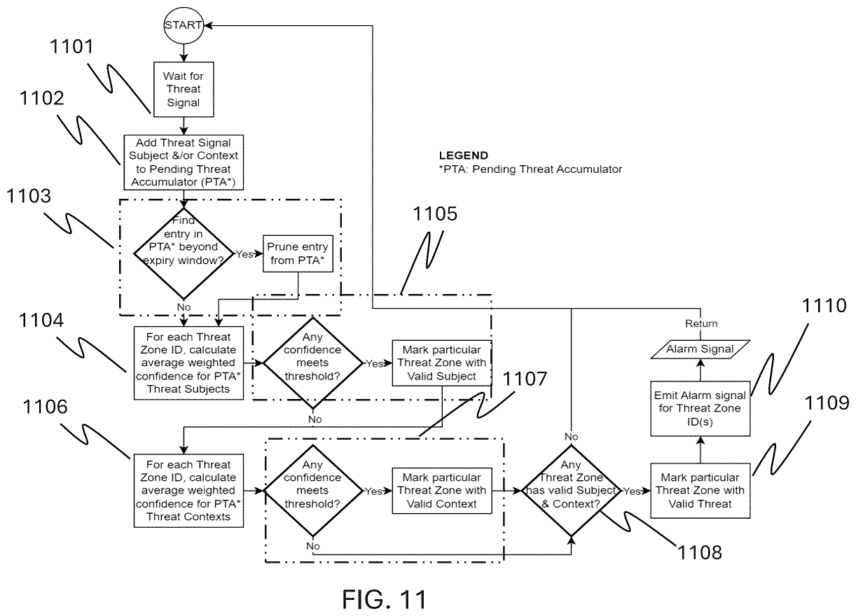

FIG. 11 illustrates an example of operation of a threat server in accordance with disclosed implementations. At 1101, the threat server waits for an incoming threat signal from a sensing module. Once the threat signal is received, the threat subject and/or threat context data of the signal is added to the pending threat accumulator, at 1102, to be analyzed. The pending threat accumulator is iterated through and any expired entries are removed at 1103. Each threat zone in the pending threat accumulator is iterated through in this manner. All threat subject confidence levels of a particular threat zone are used to calculate a weighted average of a particular threat zone at 1104. If a threat zone meets the required subject confidence level, the threat zone is marked as having a valid threat subject at 1105. All threat context confidence levels of a particular threat zone can be used to calculate a weighted average of a particular threat zone at 1106. If a threat zone meets the required context confidence level, the threat zone is marked as having a valid threat context at 1107. At 1108, if any threat zone has both at least one valid threat subject and threat context pair (1108), the threat zone is marked as having a valid threat (1109) and an alarm signal is emitted at 1110.

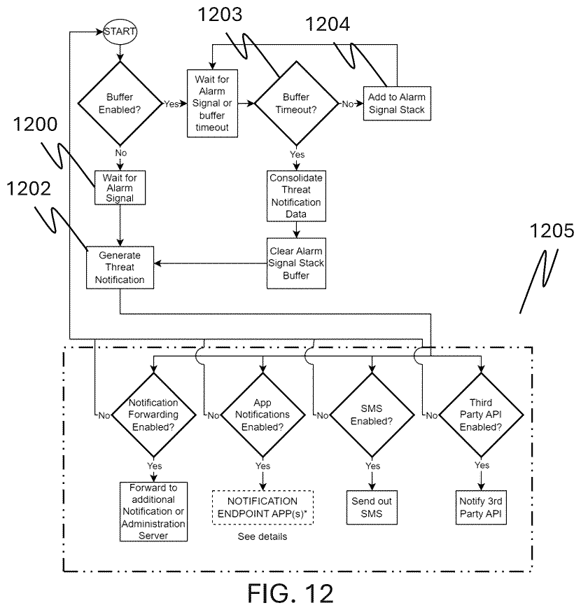

FIG. 12 illustrates an example of operation of the notification server in accordance with disclosed implementations. As shown in FIG. 12, the notification server waits for an incoming alarm signal, at 1200. When the notification server does not have an alarm signal buffer enabled, the alarm signal is immediately translated to a threat notification and sent to all enabled notification endpoints at 1202. Alternatively, if an alarm signal buffer is enabled, the notification server also listens for a buffer timeout, at 1203, which, when triggered, signifies that any and all alarm signals in the alarm signal stack buffer are to be consolidated and sent as a single threat notification to all enabled notification endpoints. In this mode, any alarm signals are immediately added to the alarm signal stack, at 1204, for batch notification. This batch mode helps decongest notification channels and ensures high quality, reliable transmission of threat notifications on channels that may be throttled or may not guarantee delivery of threat notifications to notification endpoints in the order they are sent. at 1205, logical steps are taken to apply rules for forwarding the notifications to the appropriate endpoints. Threat notifications are transmitted with timestamps to also reduce the possibility of out of order notification delivery.

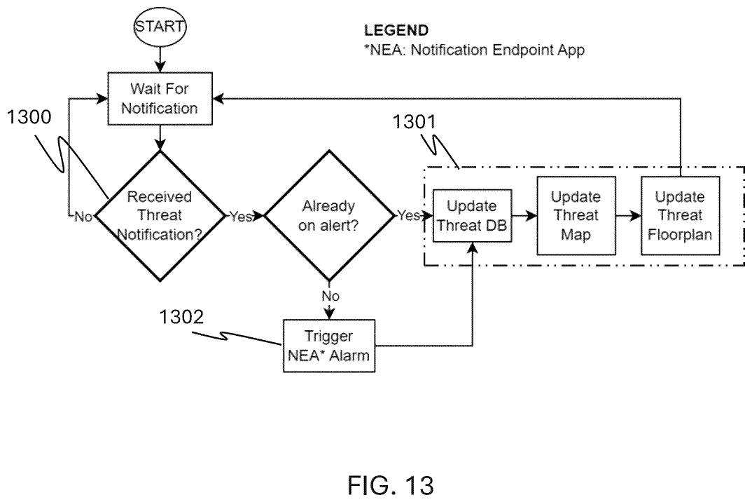

FIG. 13 illustrates an example of an endpoint application, executed on a smartphone for example, in accordance with disclosed implementations. At 1300, the notification endpoint app receives a threat notification. If the notification endpoint app has previously been set on alert, the incoming threat notification is processed quietly and quietly notifies the user of an update to the ongoing threat at 1301. If the notification endpoint app has not been set on alert, the notification endpoint app's alarm is triggered to abruptly notify the user of a threat at 1302.

Notification endpoints may be hosted by mobile apps, web apps, public-safety answering points, and third party integrations. This section discusses operation of an implementation of the notification endpoint that is hosted by a mobile app running on a mobile device as the notification endpoint app (NEA) and notification endpoint device (NED) respectively.

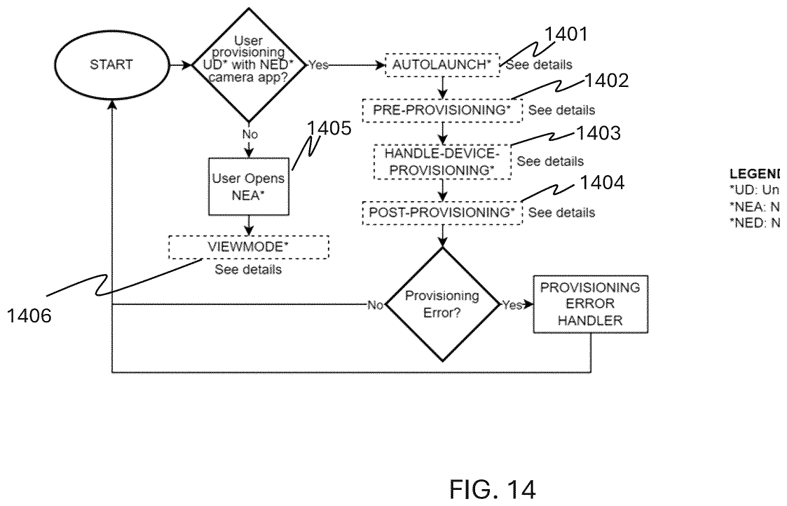

FIG. 14 illustrates a process of provisioning a sensing module using the endpoint device/app. If the user is trying to provision a new sensing module, the user enters into the autolaunch process 1401 on their notification endpoint device. Following the autolaunch process, the user enters into the pre-provisioning process 1402 on the notification endpoint app. Following the pre-provisioning process, the user enters into the handle-device-provisioning process 1403 on the notification endpoint app. Following the handle-device-provisioning process, the user enters into the post-provisioning process 1404 on the notification endpoint app. If the user encounters an error while going through any of the previous provisioning steps, the user is sent to the provisioning error handler. Otherwise, the user is returned to the start of the notification endpoint app overview.

If the user is not trying to provision a new sensing module, the user installs and opens the notification endpoint app at 1405. The user then enters into the view mode of the notification endpoint app at 1406. Provisioning of provisioned devices can be handled by the provisioning server consisting of three parts: the backend server, the front-end webpage/UI, and the provisioning part of the mobile app. This example of the notification endpoint app handles part of the role of the provisioning server. The provisioning server authenticates and validates the setup of devices. Alternatively, the provisioning server can be cloud-based or the provisioning server can be within the sensing modules themselves to enable full off-the-network autonomy. Finally, in yet another example, the entire provisioning server can be on the notification endpoint app. The location of the provisioning server influences the security of the mesh network and validity of the threat signals, alarm signals, and threat notifications. A provisioning server located at least partly in the cloud offers the greatest security and validity.

Disclosed implementations can include an “autolaunch” feature. Auto launch is a method to automatically start the provisioning of an unprovisioned device initiated by an indicator, such as a QR code scanned, for example, by using a notification endpoint device's camera app. In one disclosed implementation, the autolaunch process starts the provisioning of an unprovisioned device, i.e. a new sensing module, without requiring that the user first installs the notification endpoint app or any app that is used for provisioning. In another disclosed implementation of autolaunch, the notification endpoint app is a web app or a website. In another implementation of autolaunch, the backend server is the provisioning server.

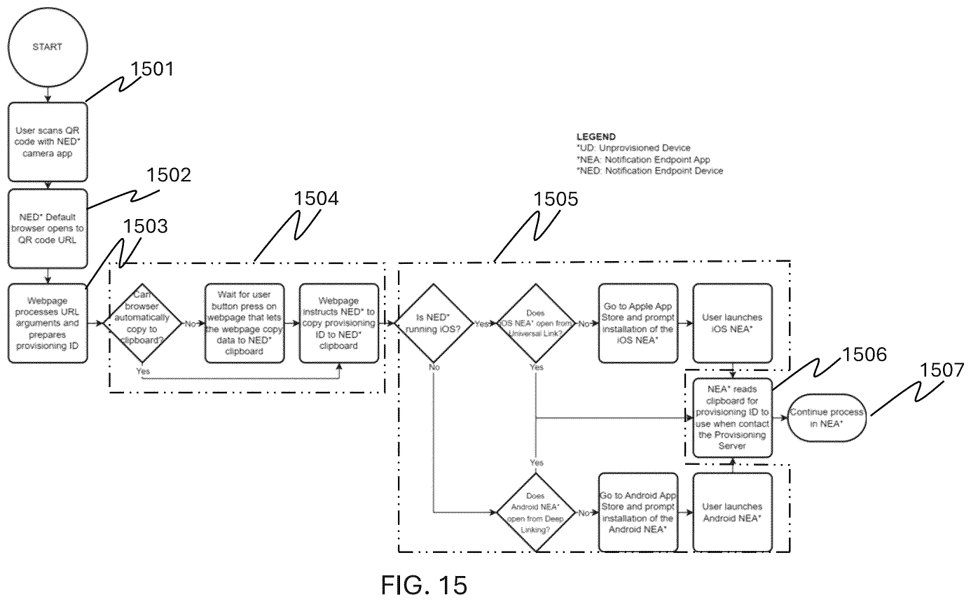

An example of the autolaunch process is illustrated in FIG. 15. At 1501, the user scans an unprovisioned device's QR code with their notification endpoint device's camera app. The notification endpoint device uses a URL indicated by the QR code to open a web page of the provisioning server at 1502. The webpage processes the autolaunch parameters, particularly the unprovisioned device's provisioning id in this case, at 1503 and can save the data to a clipboard, or other memory, of the notification endpoint device at 1504. The webpage attempts to launch the notification endpoint app using the logic at 1505. For example, if the app is not installed, the notification endpoint app's store page is loaded such that the user can install the notification endpoint app and then launch the app. In this example, iOS TM and Android TM operating systems are included. However, the devices can use any appropriate operating system. Once the user installs and launches the notification endpoint app, the notification endpoint device clipboard is parsed, at 1506, and the parsed data is used to lookup the provisioning data from the provisioning server backend to continue the provisioning process, at 1507 all without requiring the user to scan the QR code a second time on the notification endpoint app or notification endpoint device. In this example, autolaunch is able to hand-off a process to a notification endpoint app regardless of whether or not it is installed on the notification endpoint device at the time.

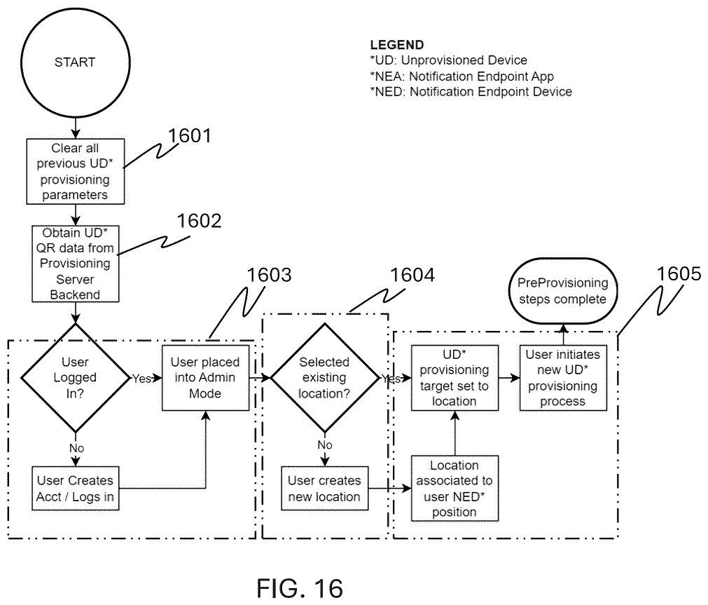

A pre-provisioning process is illustrated in FIG. 16. The notification endpoint app clears all remaining data from notification endpoint app memory from previous provisioning attempts that may have been interrupted or corrupted other than user login state at 1601. The notification endpoint app contacts the provisioning server on the backend to pull relevant information on the unprovisioned device at 1602. At 1603, the user logs in and is put into admin mode. The user either selects an existing location that their account is designated as an admin of or creates a new location based on the notification endpoint device's current location at 1604. The selected location is then set as the provisioning target for the unprovisioned device, based on the logic at 1605, to complete the pre-provisioning process.

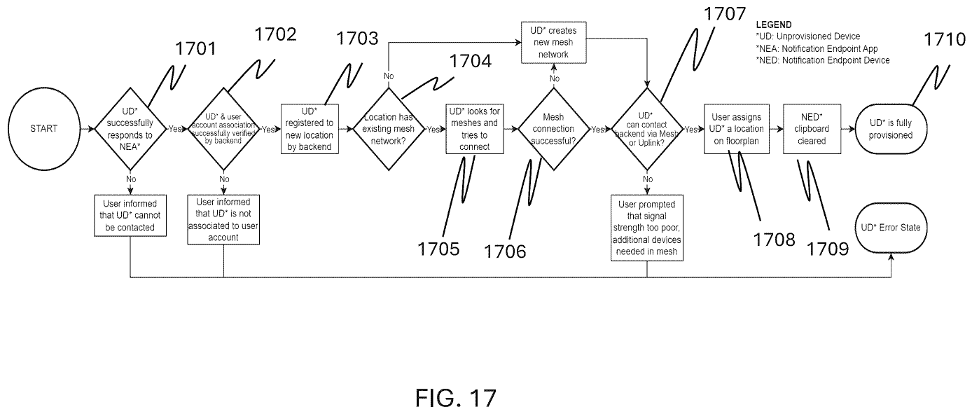

FIG. 17 illustrates the provisioning process. The user notification endpoint device executes basic sign of life tests to ensure the unprovisioned device can be contacted and is ready to be provisioned. In this example, information is pulled from the unprovisioned device in 1701 by the notification endpoint app and sent to the provisioning server backend in 1702 to demonstrate legitimacy of provisioning attempt due to proximity. This step prevents a user from remotely provisioning an unprovisioned device when not beside the unprovisioned device and also enables the unprovisioned device to execute tamper detection such that it can refuse to be provisioned if it has been modified without authentication. The provisioning server backend associates the user's account with the unprovisioned device in 1703. The provisioning server backend reports existing mesh networks at the selected provisioning target location and relays connection instructions to the unprovisioned device through the notification endpoint app such that the unprovisioned device can connect to the existing mesh networks in 1704. If the selected target location has no established mesh networks of sensing modules or those related to the threat detection system, the unprovisioned device establishes its own local mesh network and sends network information back to the provisioning server backend via the notification endpoint app. This same action is taken if the unprovisioned device cannot contact any of the pre-existing mesh networks at the selected target location. Once the unprovisioned device has either connected to an existing mesh network or created its own and reported its connection state back to the notification endpoint app, the unprovisioned device now attempts to connect to the provisioning server backend itself in 1707. The unprovisioned device first contacts other provisioned devices on its mesh network to acquire any existing routes via uplink that are online. If found, the unprovisioned device attempts a routed connection. If no outgoing route can be found in the connected mesh network, the unprovisioned device attempts to connect to the provisioning server backend via the uplink that is onboard the unprovisioned device.

If no connection can be established through both the mesh network nor the onboard uplink, a connection failure is reported to the notification endpoint app and the notification endpoint app exits provisioning mode. A possible connection solution includes adding another unprovisioned device to the same mesh network where the additional unprovisioned device is placed in a location with significantly better uplink connectivity. Once a successful connection is made by the unprovisioned device, the user is then instructed to specify the location of the unprovisioned device on the location's floor plan in 1708. At this point, provisioning has been completed and the user's clipboard is cleared in 1709 to prevent provisioning data contamination in case the user is trying to provision an additional unprovisioned device when an unexpected error occurs. The unprovisioned device now enters a fully provisioned state in 1710.

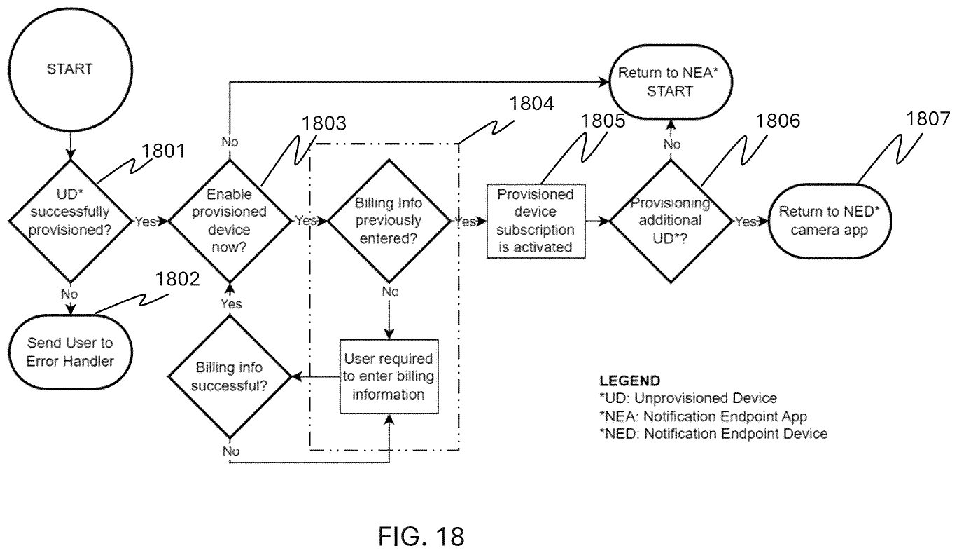

FIG. 18 illustrates an example of a post-provisioning process. At 1801, the notification endpoint app confirms that the unprovisioned device has been successfully provisioned. If an error occurred during provisioning, the notification endpoint app enters troubleshooting mode with instructions on how to debug and fix common issues, i.e., sends the user to an error handler routine, at 1802. Assuming that there was no error, the user is prompted to enable the newly provisioned device now, or later in case of multiple devices being provisioned, at 1803. If the user attempts to enable the newly provisioned device without having entered billing information previously, they are prompted to do so, at 1804, before the newly provisioned device can be enabled. Once billing information is confirmed, the newly provisioned device's subscription is activated and the newly provisioned device is enabled for use in the system, at 1805. The user is then prompted to either return to the notification endpoint app in view mode, or return to the notification endpoint device's camera app to provision additional devices at 1806. Once the process is completed, the endpoint app can be returned to the camera mode to scan another device, if appropriate, at 1807.

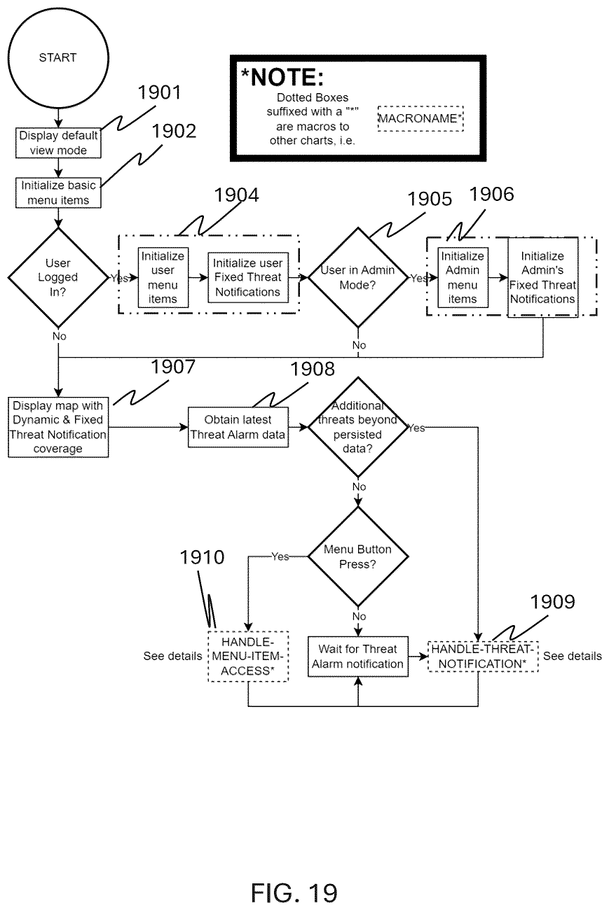

FIG. 19 illustrates an example of the operation of the view mode of an endpoint device. At 1901, the user's notification endpoint app enters view mode and the notification endpoint app initializes basic functionality at 1902. At 1903, the notification endpoint app checks if the user is logged in. If so, additional menus selections particular to the user such as fixed threat notifications are presented on the UI, at 1904. The notification endpoint app then checks if the user is in admin mode, at 1905, and if so, initializes additional admin functionality and advanced fixed threat notifications that provide more granular detail on threat notifications at 1906.

The notification endpoint app then initializes the main map display with outlines of current coverage zones managed by the union of dynamic threat notification zones and fixed threat notification zones at 1907. The notification endpoint app then obtains latest threat alarm data from an administrative server at 1908. For example, a notification server can be queried such that any missed threat notifications can be downloaded to the notification endpoint app and presented to the user. Causes for missed notifications include but are not limited to a user's phone being powered off, the notification endpoint app not being installed, a back-end server glitch or restart, a failure to deliver threat notifications to an endpoint, or the like. If any new information on active threats is now present on the notification endpoint app, the threat notification handler is executed at 1909. If a menu item is pressed, the handle-menu-item-access process is executed at 1910. Otherwise, the notification endpoint app remains in a dormant state, awaiting additional user input or threat notifications.

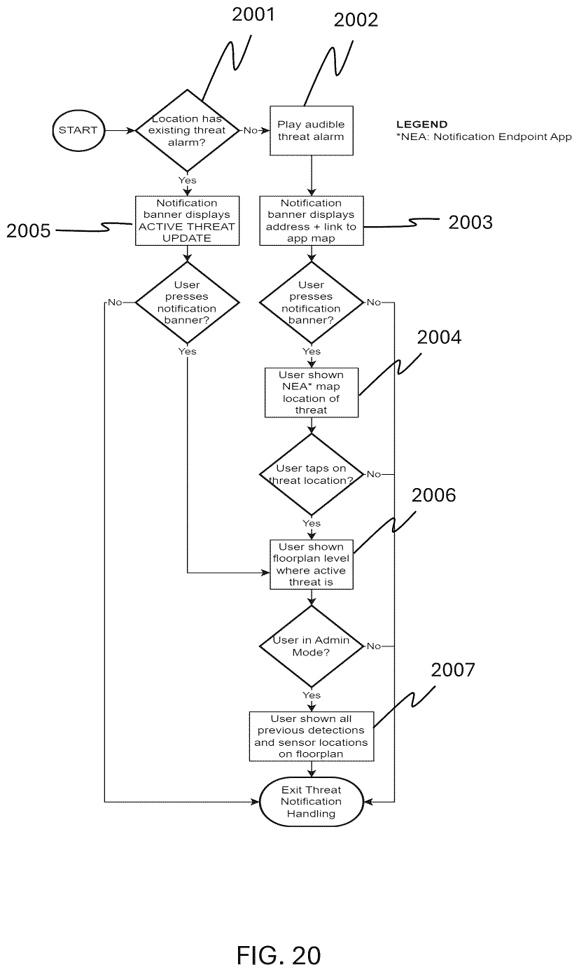

FIG. 20 illustrates an example of a threat handler algorithm. Upon receiving a threat notification, the handle threat notification process checks if the notification is for a location that already has an ongoing threat situation that the user has been notified of at step 2001. If the user has not been notified of the threat previously, the notification endpoint app produces an audible alarm by default step 2002. The user is then shown a notification banner displaying the address and a map location of the new threat at 2003. If the user opens the notification endpoint app via a banner notification and taps on the threat location, the user is shown a floor plan indicating where the threat has been detected at 2004. If the user has already been notified of the threat previously, the notification endpoint app displays a banner notification notifying the user of an “active threat update” and shows the user a snippet of where the threat is on the floor plan at 2005. If the user taps on the banner, the notification endpoint app opens and displays the threat on the floor plan along with any previous information, such as previous threat locations at 2006.

If the user is an administrator at the time of viewing the floor plan, all provisioned devices at the location are shown with their respective states at 2007. Advanced information about each sensor can be made viewable, including but not limited to confidence levels of detections. The user in admin mode can also adjust the minimum threat signal confidence levels of the threat servers and threat processors such that additional, lower confidence data can be reported to the admin user while refraining from triggering potentially spurious threat notifications from going to public notification endpoints. This can be useful to provide first responders higher levels of detail and real time data during an active threat situation while continuing to filter the public channels to only report full confidence threats.

The disclosed implementations are capable of providing protection and awareness of shooting threats before they occur while also maintaining privacy. However, the disclosed implementation can also be used as a trigger to enable non-privacy oriented data collection and streaming in the event of a threat. Disclosed implementations can be interfaced with access control systems where, for example, doors can lock, or lock, upon detection of a threat. Similarly, other systems and actions can also be triggered. These other actions could include moving pan-tilt-zoom cameras to focus in on an area of interest. Disclosed implementations can include software and/or hardware that is completely disabled until a valid threat detection occurs. In this case, the disabled software or hardware can then enable and begin transmitting data. Stated differently, the system could protect privacy until a shooting or other threat was detected. Once a threat is detected, privacy protection can be adjusted in favor of, for example, real time streaming of data about the threat to first responders to help deescalate the situation as quickly and safely as possible.

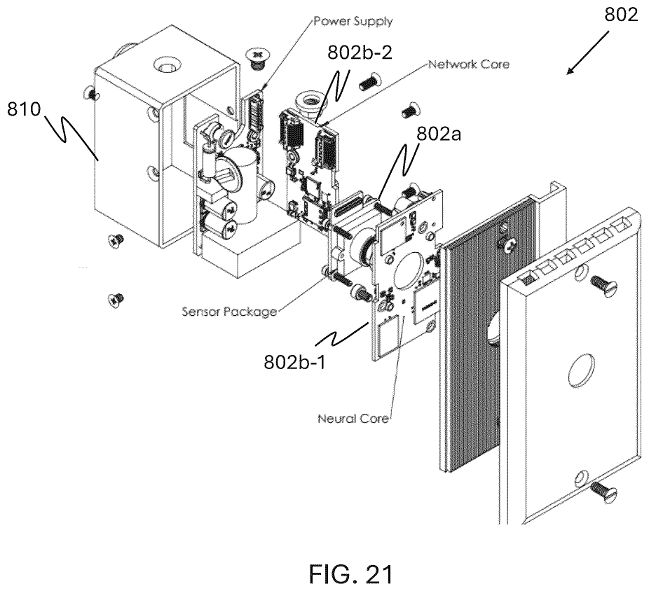

FIG. 21 illustrates an example of sensing module 802 (FIG. 8) that can be installed in a conventional “single gang” box 810, for example, in place of an existing outlet or light switch, whereby existing power can be used to power to sensing module 802. Corresponding elements in FIG. 8b are labelled the same in 8b as in FIG. 8. Sensor package 802a can include, for example, a video camera that monitors a room in which the sensing module is located.

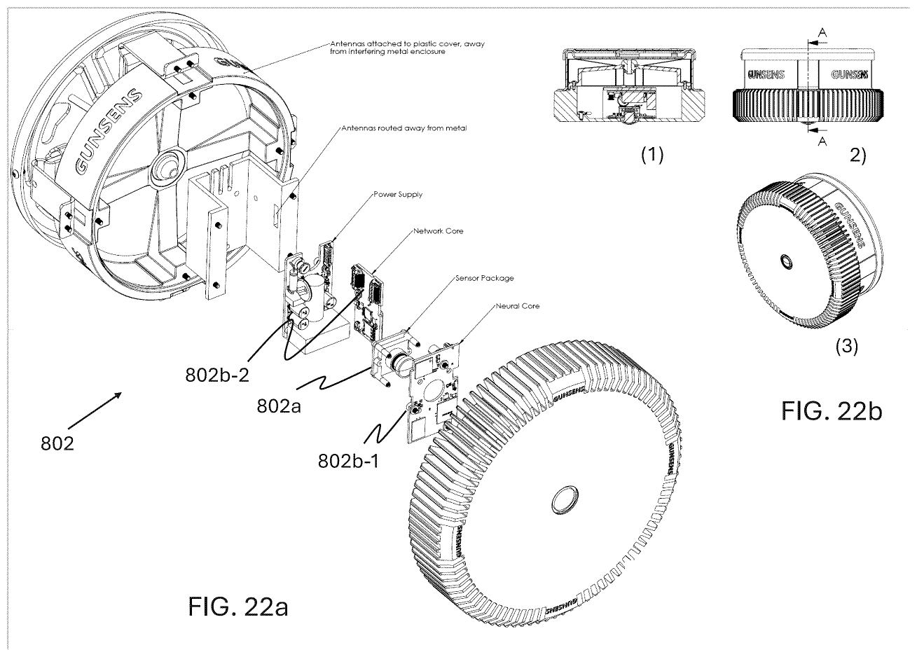

FIG. 22a illustrates an example of sensing module 802 (FIG. 8) that can be installed on a ceiling of a room, in a manner similar to a conventional smoke detector or light bulb for example. Corresponding elements in FIG. 8 b are labelled the same in 8b as in FIG. 8. Sensor package 802a can include, for example, a video camera that monitors a room in which the sensing module is located. Further, in this example, sensor package 802 can include novel optics that facilitate threat detection. These optics, and related signal processing are described below. FIG. 22b shows the sensing module of FIG. 8c in section (1), side view (2) and perspective (3).

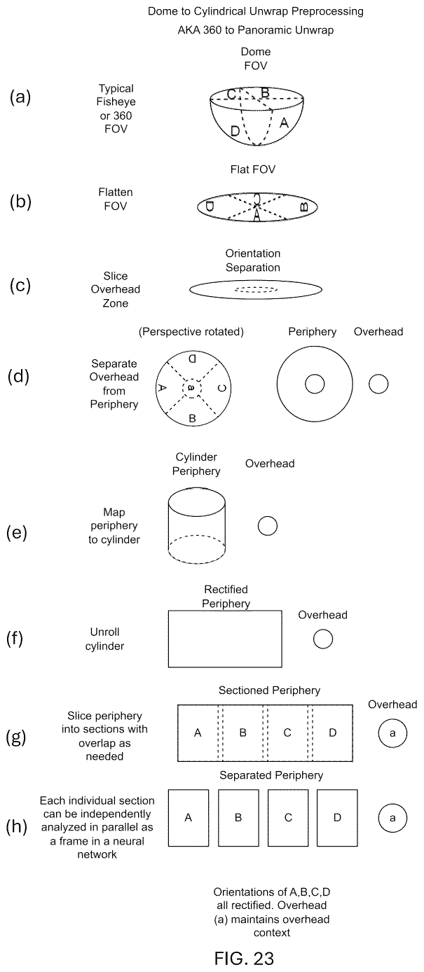

FIG. 23 schematically illustrates the optics and image rectification processing of sensing module 802 of FIG. 22a. Keep in mind that, in this example, sensing module 802 is mounted on the ceiling, near the middle of the room, and an image capture device thereof, such as a video camera, is pointed substantially straight downward. At (a), the image of the field of view (the room from above) is captured through a conventional 360 degree fisheye lens. This image can be divided into multiple regions (A, B, C, and D as shown). At (b), the image is flattened. At (c) a middle portion of the image is selected as an overhead view and the rest of the image is selected as a periphery view. At (d), the overhead view is separated from the periphery view. At (e), the periphery view is mapped to a cylindrical shape. At (f), the cylinder is “unrolled’ to rectify the periphery. At (g), the rectified periphery is sliced into plural consecutive sections (A, B, C, D corresponding to regions A, B, C, D respectively in this example) and the overhead view (a). At (h), each individual section can be independently analyzed, for example as frames in a neural network. Other processing can be similar to processing described with respect to other examples herein.

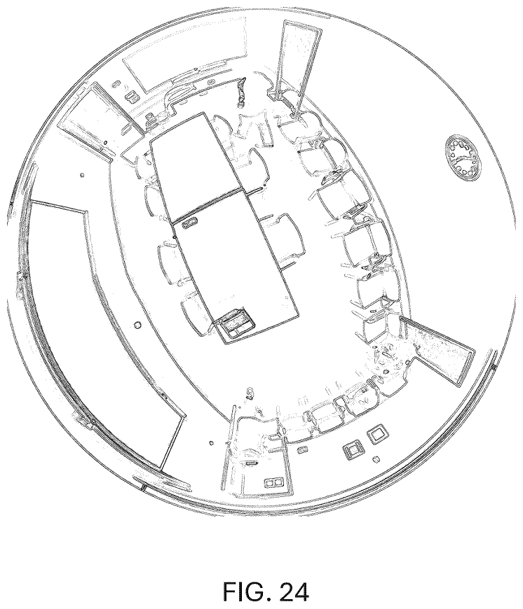

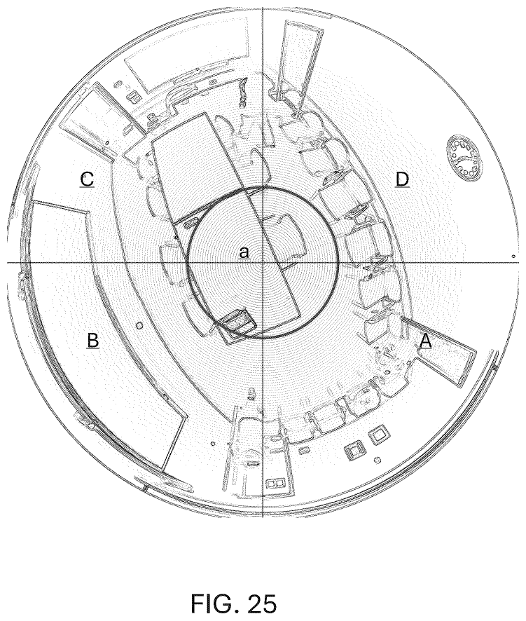

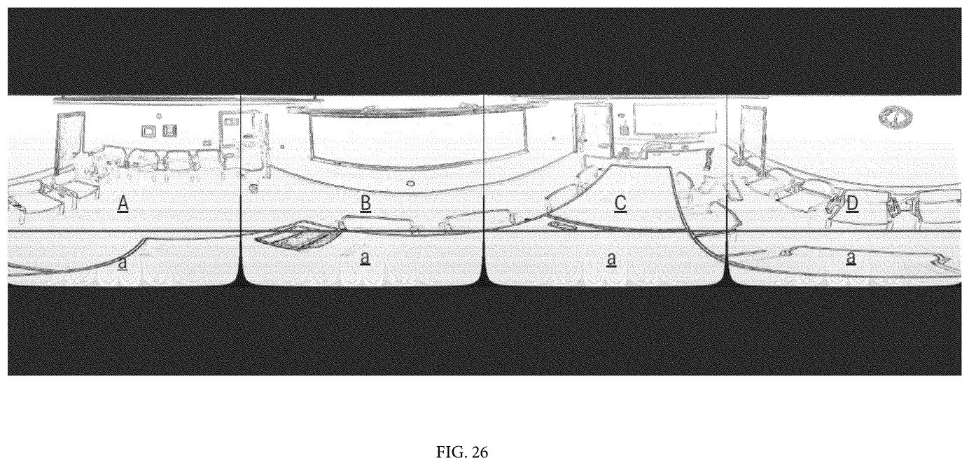

FIG. 24 illustrates an example of the fisheye image captured at (a) of FIG. 23. In this example, the image is of a typical conference room. FIG. 25 illustrates the separation of the overhead view and the periphery view of (c) of FIG. 23. FIG. 26 illustrates the rectified periphery sections of (g) of FIG. 23. As noted above, these image sections can be fed, along with the overhead view, as N frames, into a neural network to represent the original single 360 degree view. One of skill in the art will readily ascertain that input aspect ratios and overlap of the images can be adjusted as needed for detection accuracy.

FIG. 25 illustrates the dividing method overlayed onto an existing fisheye (FIG. 24), where the central overhead view is encircled near the center of the fisheye. When unwrapped in FIG. 26, one can see that the central overhead view found below the thick horizontal black line is substantially warped. Therefore, this lower section is ignored in the unwrapped data, and instead the original fisheye is cropped to this same region to produce the overhead image frame “a” in sections (g) and (h) of FIG. 23.

One example of triggering external systems/actions includes automatic enabling of live streaming, triggered by the threat alert, from a device (e.g., a mobile phone) that is within close proximity (e.g., Bluetooth or Geofence) of a device on the same network as the triggering device. For example, assume that a threat has been detected and an alert notification has been transmitted to endpoints. A mobile app (acting as an alert notification endpoint) receives this alert and can determine if it is within Bluetooth range of a sensor module on the same mesh network as the sensor module that triggered the alert notification. If so, the mobile device can automatically begin live streaming via its own mobile phone's WAN connection. This live stream then provides first responders with actionable real-time audio and video information directly from a device that is proximate to the threat. This live stream can be viewed by anyone (if permissions are set accordingly) in real-time or at a later time.

A user may also act as a sensor using, for example, a notification endpoint app having an SOS alert button. The SOS alert button can be used to manually generate an alarm signal. This feature is especially useful in situations where a threat, such as a knife attack, is not detected or cannot be detected by a sensing module of a certain configuration. When the user senses a threat, the user taps the SOS button to trigger an alarm signal in the same exact way that a threat detected by a sensing module which then gets relayed to other notification endpoints via a notification server. This feature enables the threat detection system to utilize human acuity and experience to detect situations that may not be detectable with installed sensing or detecting capabilities. This ability to trigger an SOS through the threat detection system network can also work to verify ongoing threats and feed additional information out to first responders and the public.

Multiple sensing modules in a facility can enable the determination of the movement of a threat through a facility. Multiple sensing modules with overlapping coverage areas increase accuracy and speed of threat detection. Newly provisioned devices that may have a better connection via their own uplink than previously provisioned devices on the same mesh network, may trigger a topology update that configures a new set of efficient routes for outgoing connections.

The disclosed implementations can also provide a safety system that seamlessly integrates one or more autonomous AI agents for shooting threat detection, an SOS panic button, a live bodycam, a structured membership system, guided navigation, and real-time notification capabilities. The system allows for automatic detection of shooting threats, manual activation of emergency alerts, real-time video streaming, tiered user management, locked screen notifications, and location-based guidance to help users navigate to or away from threat areas.

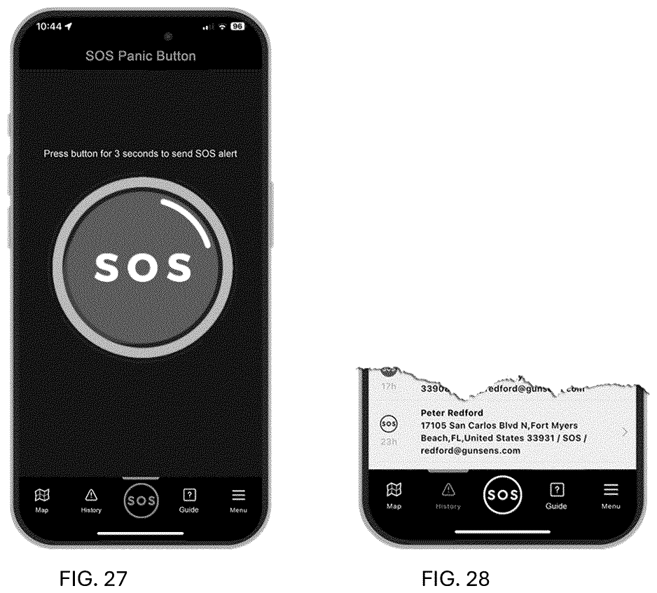

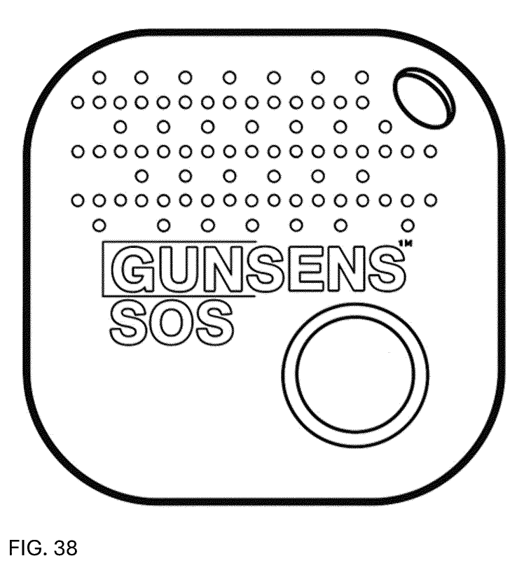

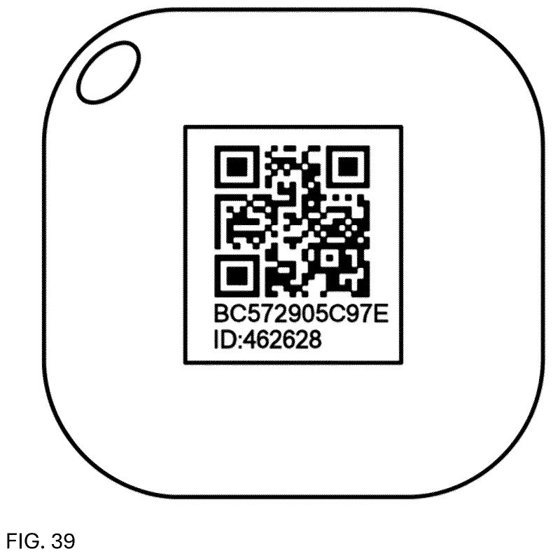

Autonomous AI agents can employ computer vision models and machine learning algorithms to autonomously identify potential gun threats. When an unholstered firearm is detected, the autonomous AI Agent can trigger a shooting threat alert that is immediately relayed to designated users. An SOS panic button allows users to manually trigger an emergency alert in situations where a threat may not be detected automatically, such as a knife attack. As shown in FIG. 27, the panic button can be activated via a user interface of the app, and/or via a hardware SOS Remote, instantly notifying users and initiating emergency protocols. As shown in FIG. 28, a tab bar of the user interface can be used to select a live bodycam (or the smartphone camera) to enable real-time video streaming from the app. This video is accessible to authorized users, providing situational awareness and allowing emergency responders to remotely assess the threat. As noted above, the SOS panic button can be a virtual button integrated within the app; However, the SOS panic button can also be a discrete external hardware button interfaced to the app via a communication technology like Bluetooth or Bluetooth Low Energy (BLE). FIG. 38 illustrates an example of such as hardware button as a hardware tag with an actuator. FIG. 39 illustrates another example as a hardware tag with a QR code that allows a camera of a mobile phone to read the QR code and present a link to a SOS panic button.

The system of disclosed implementations can be designed to manage user roles and responsibilities through a tiered membership structure consisting of, for example, three levels: Owners, Admins, and Viewers. This hierarchy ensures appropriate access and control, enhancing the system's functionality in complex environments like schools, businesses, and public spaces. For example, in a school setting, the school principal can act as the Owner, teachers as Admins, and students as Viewers. Students are automatically subscribed to the SOS panic button, with the Owner billed monthly for each subscription. The system supports the import of large Viewer lists for quick additions.

Owners can add and remove Admins and Viewers, manage sensors, approve Viewer SOS alerts, and pay for SOS subscriptions for invited Viewers. Admins can add and remove Viewers, manage sensors, and approve Viewer SOS alerts. Viewers have access to the app's features without making changes and can use the SOS panic button without subscription fees.

A system interface integrates the above components, presenting alerts, notifications, and live video streams within a single dashboard. The interface allows for efficient navigation between alerts and location-based tasks, ensuring swift responses in emergencies.

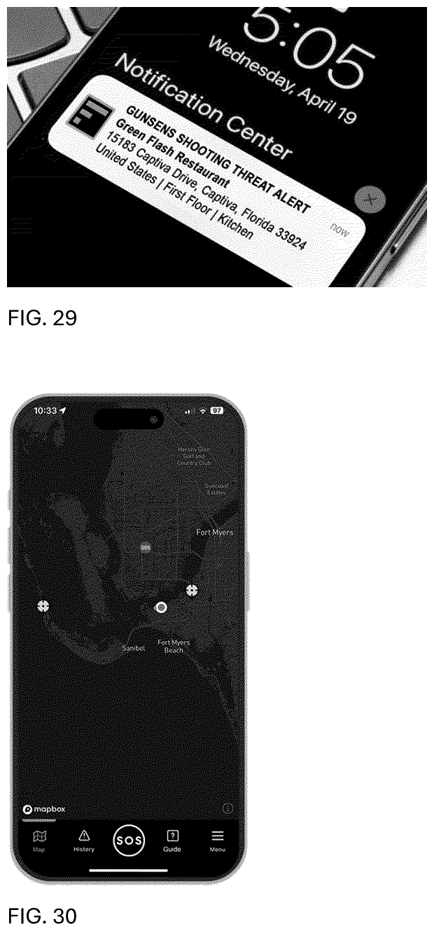

Upon detecting a shooting threat or manual SOS activation, the system can initiate workflows such as notifying authorities, locking down locations, or activating emergency protocols, depending on user-defined settings. As shown in FIG. 29, The user interface can include the display of real-time alerts directly to the locked screens of smartphones of both first responders and the public when a shooting threat is detected or an SOS alert is initiated. This feature extends the system's reach, ensuring immediate awareness and rapid response across broad audiences.

The system can include a guided navigation feature that provides location-based directions, using GPS technology for example, to help users safely navigate to secure locations or away from threat areas. The guided navigation system is designed to provide users with location-based directions and guidance during emergency situations. When a threat alert is activated, the system generates navigation routes that help users find safe areas or exit routes. The guided navigation integrates with real-time threat data, ensuring that the guidance adapts dynamically as the situation evolves. For example, if an active shooter moves around a building, the users will be guided to doors in locations remote from the shooter.

The locked screen notification system enhances real-time awareness by sending threat alerts to recipients'locked screens. Notifications are triggered automatically by an autonomous AI agent or manually by an SOS panic alert button, and appear immediately on the devices of authorized users and members of the public who have opted in to receive such notifications. This feature allows for rapid dissemination of information beyond the confines of emergency responders, thereby increasing situational awareness and safety for all potential targets in the affected area

[symbol]

Upon opening the app, users can be directed to the Map screen, as shown in FIG. 30, which displays active threat alerts and provides access to the Alert Tab Bar for managing these alerts. Color-coded icons on the map can represent shooting threats, and SOS alerts, and the like. Tapping an icon causes more detail to be displayed on the user interface.

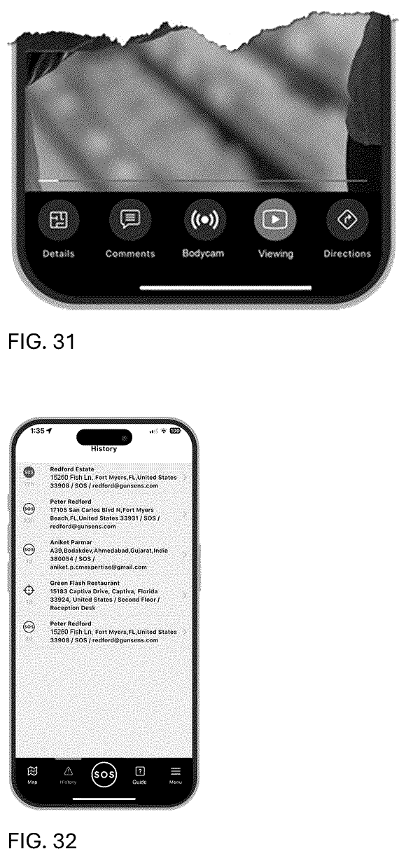

The user interface can include two tab bars for managing threat alerts. The Alert Tab Bar (FIG. 28) provides an overview of active and inactive alerts, while the Location Tab Bar, shown in FIG. 31, becomes available when a specific alert is selected, offering tools for tasks related to that location. This two-tiered system ensures efficient navigation and response in critical situations.

As noted above, upon opening the app, users are directed to the Map screen, which displays active threat alerts and provides access to the Alert Tab Bar for managing these alerts. A History screen, shown in FIG. 32, shows all alerts in chronological order. Active alerts are marked with yellow and red indicators, while inactive alerts are shown in black and white. Alerts automatically deactivate after 24 hours.

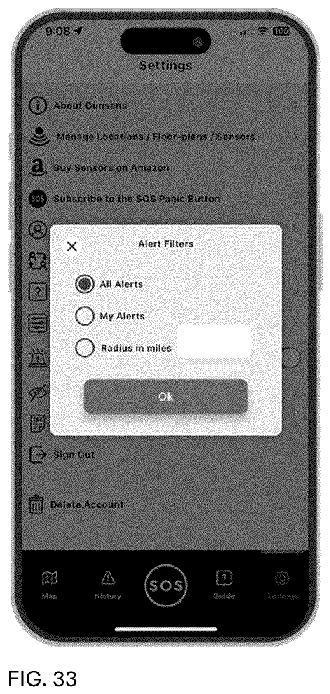

The user interface can allow a user to filter which threat alerts are displayed by tapping the Menu item on the tab bar and select the Alert Filters item. This brings up a filter definition box, as shown in FIG. 33. For example, a user can filter alerts by distance, such as viewing only alerts within a 9-mile radius of your current location.

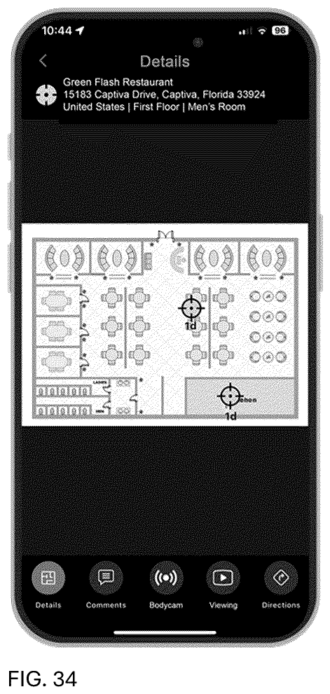

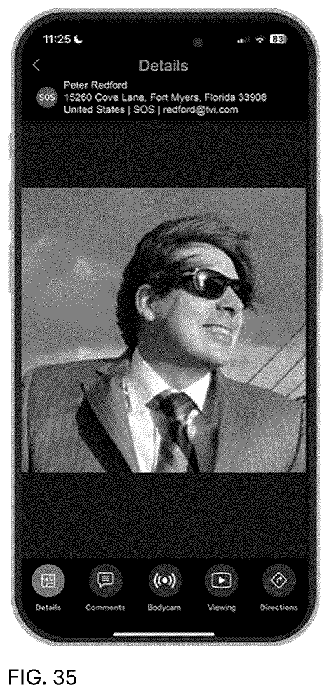

When an alert is selected, either from the History screen or the Map, the app navigates to the Details screen, where the Location Tab Bar provides tools for managing tasks related to that specific location. If a shooting threat detector triggers the alert, the Details screen displays, for example, a floor plan showing the exact location of the threat, including the floor number, as shown in FIG. 34. If the alert was triggered by the SOS panic button, the Details screen shows, for example, the member's photo, location, and contact information, as shown in FIG. 35.

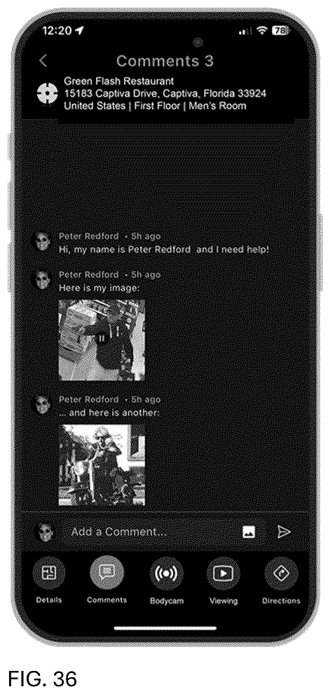

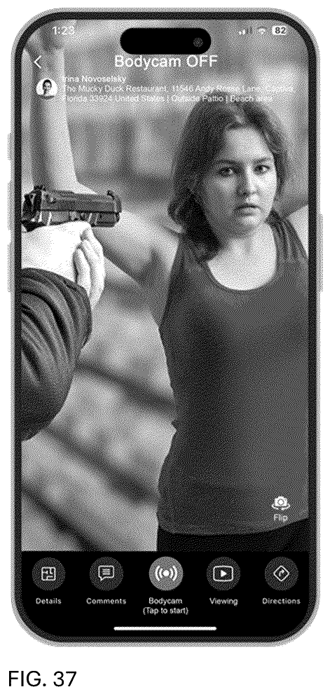

A user can provide comments regarding a specific threat by tapping the Comments item on the Location Tab Bar. An image can be included with a comment by using use the media button within the text input box, as shown in FIG. 36. As shown in FIG. 37, a user can tap on the Bodycam item to start a livestream related to the current alert and tap a second time to stop the livestream. To view all the live and saved videos associated with the current location, a user can tap on the Viewing item and swipe up-down to move between the videos. To get directions to the location of an alert, a user can tap the Directions item on the Location Tab Bar or select the alert indicator from the shooting threat Details screen.

Shooting threat detectors (also called “sensors” herein) can be added to an account in four simple steps: (1) add a location, (2) upload a floor plan, (3) scan the sensor's QR code, and (4) position the sensor on the floor plan. An account can include multiple locations, and each location can have several floor plans. You can add multiple sensors to each floor plan. Sensors can be added, deleted, moved, and otherwise managed through the user interface of the app. Once added, a sensor will appear as an icon, such as a red pin, on the uploaded floor plan. The icon can be dragged to the desired position on the floorplan or on a map.

The user interface of the app can be used to effectively manage and respond to threat alerts by using a structured membership system. Different users play different roles in ensuring safety, from receiving notifications to managing alerts and sensors. To handle these varying responsibilities, accounts are divided into, for example, the three membership tiers, as noted above: Owners, Admins, and Viewers. This hierarchy ensures that every user has appropriate access and control, enhancing the app's functionality in complex environments like schools, businesses, and public spaces.

In a school setting, for example, the principal acts as the Owner, invites teachers as Admins, and teachers invite students as Viewers. Students are automatically subscribed to the SOS panic button, and the Owner account can be billed on a per user subscription each month. Large Viewer lists can be imported to quickly add many students, for example. If a party belongs to multiple Owner accounts, the party can easily switch between them by selecting a Change Accounts option on a Settings screen of the user interface.

Indoors, sensors can be installed similarly to ceiling lights or smoke detectors, consisting of a detector unit and mounting bracket. Outdoor sensors can be weather proof and can be installed like security cameras, on walls or lamp posts.

In other disclosed implementations, upon receiving a threat alert—whether generated automatically by detectors, manually by individuals at the threat location, or by external emergency systems such as computer-aided dispatch (CAD) platforms—the system can automatically direct various vehicles/equipment (such as airborne drones or autonomous land-based robots, to the precise location of the threat and provide live data coverage, such as video streams, for enhanced situational awareness. The vehicles/equipment could also transport any other personnel and/or equipment to the location as needed by the specific situation.

As noted above, threat alerts can be generated automatically by detectors (for example, detectors employing artificial intelligence, motion sensing, acoustic sensing, or environmental sensors such as smoke detectors), manually by an individual at the threat location, or by external systems such as police CAD platforms in response to emergency calls.

Upon receipt of an alert, drones can navigate to the reported location—identified by GPS coordinates or sensor-provided data—and stream live video and other data to enhance situational awareness. These data streams can be distributed through servers or delivered to applications and web interfaces for real-time or recorded playback.

As noted above, each alert can include location information, expressed as GPS coordinates or sensor-reported location data, and is transmitted through an API. Drone systems can be configured to receive threat alerts in real time via the API. Upon receiving an alert, the drones can be automatically dispatched by a server or platform connected to the alerting system. Drones may be operated by the owner of the detectors, emergency services, or independent third parties.

Once dispatched, the drones can autonomously navigate to the reported location and initiate live data streaming or other actions. The data stream may include video, thermal imaging, or other sensor data. Streams are transmitted to servers or other platforms, enabling real-time viewing by first responders, emergency personnel, or other authorized entities. Video and data may be accessed through any platform capable of playback or data display.

Video feeds can be displayed in a mobile app, integrated into emergency response dashboards, shared with press outlets, or streamed to secure cloud services for archiving. Data feeds may be used by first responders and authorized third parties to reconstruct simplified representations of the environment in bandwidth-constrained situations. The system enables rapid deployment of situational awareness tools during emergencies, without requiring human intervention.

The invention has been disclosed the implementations and examples thereof. One of skill in the art will readily see that the disclosed implementations can be modified and combined. Such implementations and examples are not limiting to the scope of the invention as defined by the appended claims.

What is claimed:

1. A threat detection system comprising:
a sensing module located proximate a coverage zone, the sensing module including:
at least one sensor configured to capture environmental data relating to the coverage zone and generate sensor data; and
a threat processor configured to analyze the sensor data and detect at least one of a threat subject and/or threat context in the coverage zone based on the sensor data and generate a threat signal based on detecting the threat subject or threat context, wherein the threat signal includes at least one of the threat signal and the threat context,
wherein the threat processor includes at least one artificial intelligence (AI) agent trained to identify and generate alerts for potential threats based on visual recognition of firearms; and
a threat notification module including remotely coupled to the sensing module over a communications network and including:
a threat server configured to receive the threat signal from the sensing module, analyze one or more threat signals to determine if a valid threat exists, and generate an alarm signal when a valid threat is determined to exist; and
a notification server configured to receive the alarm signal from the threat server, generate a threat notification based on the alarm signal and transmit the threat notification to at least one notification endpoint.

2. The threat detection system of claim 1, further comprising a mobile application executing on mobile user device and including a user interface (UI) that presents and SOS panic button integrated to allow users to manually initiate emergency alerts for threats not detected by the at least one autonomous AI agent.

3. The threat detection system of claim 2, wherein the mobile application includes a bodycam feature that enables real-time video streaming from a user device to thereby provide situational awareness and remote monitoring capabilities.

4. The threat detection system of claim 2, wherein the mobile application includes a membership module comprising at least three tiers of users: Owners, Admins, and Viewers, where each tier has distinct permissions for accessing and managing alerts, sensors, and emergency responses.

5. The threat detection system of claim 2, wherein the mobile application includes a locked screen notifications module configured to send real-time alerts to the locked screens of authorized users and members of the public upon detection of a shooting threat by the at least one AI agent or initiated by activation of the SOS panic button.

6. The threat detection system of claim 2, wherein the mobile application includes a navigation module that provides location-based directions to help users navigate to secure areas or away from active threat locations, based on real-time threat data.

7. The threat detection system of claim 2, wherein the UI of the mobile application includes a unified threat management interface that displays threat alerts, panic notifications, and live video streams, allowing for efficient navigation and management of emergency situations.

8. The threat detection system of claim 1, wherein the at least one AI agent utilizes computer vision and machine learning algorithms to minimize false positives while maintaining high accuracy in detecting threats.

9. The threat detection system of claim 5, wherein the wherein the locked screen notifications module is configured to notify both first responders and members of the public, who have opted to receive alerts, providing immediate situational awareness to a broad audience.

10. The threat detection system of claim 6, wherein the navigation module dynamically updates the navigation routes based on changes in threat conditions or new information from active alerts.

11. The threat detection system of claim 3, wherein the live bodycam feature supports multiple simultaneous video streams from different users, providing various perspectives of the threat location to improve situational awareness for emergency responders.

12. The threat detection system of claim 1, further comprising a drone system for dispatching a drone to location data included in the threat context, wherein the drone has a camera a live feed transmission capability.

13. The threat detection system of claim 12, wherein the location data includes GPS coordinates or a sensor-reported location.

14. The threat detection system of claim 12, wherein the drone is dispatched by a third-party server that receives the alert through the API.

15. The threat detection system of claim 1 further comprising a hardware-based SOS panic button configured to allow users to manually initiate emergency alerts for threats not detected by the at least one autonomous AI agent.

16. The threat detection system of claim 15, where the SOS panic button is a hardware tag with an actuator.

17. The threat detection system, of claim 15, where the SOS panic button is a hardware tag with a QR code that allows a camera of a mobile phone to read the QR code and present a link to a SOS panic button.

18. A threat detection method comprising:
sensing a threat with a sensing module located proximate a coverage zone, the sensing module including at least one sensor configured to capture environmental data relating to the coverage zone and generate sensor data and a threat processor configured to analyze the sensor data and detect at least one of a threat subject and/or threat context in the coverage zone based on the sensor data and generate a threat signal based on detecting the threat subject or threat context, wherein the threat signal includes at least one of the threat signal and the threat context, wherein the threat processor includes at least one artificial intelligence (AI) agent trained to identify and generate alerts for potential threats based on visual recognition of firearms; and
generating a threat signal with a threat notification module including remotely coupled to the sensing module over a communications network and including:
receiving the threat signal by a threat server;
analyzing the threat signal by the threat server to determine if a valid threat exists, and generate an alarm signal when a valid threat is determined to exist; and
receiving the alarm by a threat notification server;
generating a threat notification based on the alarm signal: and
transmitting the threat notification to at least one notification endpoint.

19. The threat detection method of claim 18, wherein a mobile application executing on mobile user device and including a user interface (UI) presents and SOS panic button integrated to allow users to manually initiate emergency alerts for threats not detected by the at least one autonomous AI agent.

20. The threat detection method of claim 19, wherein the mobile application includes a bodycam feature that enables real-time video streaming from a user device to thereby provide situational awareness and remote monitoring capabilities.

21. The threat detection method of claim 19, wherein the mobile application includes a membership module comprising at least three tiers of users: Owners, Admins, and Viewers, where each tier has distinct permissions for accessing and managing alerts, sensors, and emergency responses.

22. The threat detection method of claim 19, wherein the mobile application includes a locked screen notifications module configured to send real-time alerts to the locked screens of authorized users and members of the public upon detection of a shooting threat by the at least one AI agent or initiated by activation of the SOS panic button.

23. The threat detection method of claim 19, wherein the mobile application includes a navigation module that provides location-based directions to help users navigate to secure areas or away from active threat locations, based on real-time threat data.

24. The threat detection method of claim 19, wherein the UI of the mobile application includes a unified threat management interface that displays threat alerts, panic notifications, and live video streams, allowing for efficient navigation and management of emergency situations.

25. The threat detection method of claim 18, wherein the at least one AI agent utilizes computer vision and machine learning algorithms to minimize false positives while maintaining high accuracy in detecting threats.

26. The threat detection method of claim 22, wherein the wherein the locked screen notifications module is configured to notify both first responders and members of the public, who have opted to receive alerts, providing immediate situational awareness to a broad audience.

27. The threat detection method of claim 23, wherein the navigation module dynamically updates the navigation routes based on changes in threat conditions or new information from active alerts.

28. The threat detection method of claim 20, wherein the live bodycam feature supports multiple simultaneous video streams from different users, providing various perspectives of the threat location to improve situational awareness for emergency responders.

29. The threat detection method of claim 18, further comprising dispatching a drone to location indicated by location data included in the threat context, wherein the drone has a camera a live feed transmission capability.

30. The threat detection method of claim 29, wherein the location data includes GPS coordinates or a sensor-reported location.

31. The threat detection method of claim 29, wherein the drone is dispatched by a third-party server that receives the alert through the API.

32. The threat detection method of claim 18, further comprising manually initiating an emergency alert with a hardware-based SOS panic button for threat not detected by the at least one autonomous AI agent.

33. The threat detection method of claim 32, where the SOS panic button is a hardware tag with an actuator.

34. The threat detection method, of claim 32, where the SOS panic button is a hardware tag with a QR code that allows a camera of a mobile phone to read the QR code and present a link to a SOS panic button.
